(19) United States
(12) Patent Application Publication
(10) Pub. No.: US 2016/0376709 A1
(43) Pub. Date: Dec. 29, 2016

(54) INDUSTRIAL PRODUCTS FORMED FROM PLATED POLYMERS

(71) Applicant: UNITED TECHNOLOGIES CORPORATION, Farmington, CT (US)

(72) Inventors: Camelia GALOS, Manchester, CT (US); Grant O. COOK, Spring, TX (US); James T. ROACH, Vernon, CT (US); Glenn LEVASSEUR, Colchester, CT (US); Shari L. BUGAJ, Haddam, CT (US)

(21) Appl. No.: 14/903,300

(22) PCT Filed: Jul. 9, 2014
(86) PCT No.: PCT/US2014/045866

§ 371 Date: Jan. 7, 2016

Related U.S. Application Data
(60) Provisional application No. 61/844,088, filed on Jul. 9, 2013.

(51) Int. Cl. C23C 18/16; C25D 5/56; C25D 7/00; C23C 18/31; B64G 1/10; G21F 5/06; F24F 13/00; F25D 23/00; B63G 8/00; C25D 5/02; C23C 18/20

(52) U.S. Cl. CPC C23C 18/165; C25D 5/022; C25D 5/56; C25D 7/00; C23C 18/31; C23C 18/2073; C23C 18/1603; G21F 5/06; F24F 13/00; F25D 23/00; B63G 8/001; B64G 1/10; B63G 2008/002

(57) ABSTRACT

An industrial product comprising a polymer substrate formed in a shape of the industrial product, and a metallic plating layer plated on at least one surface of the industrial product is described. The industrial product may be nuclear waste equipment, industrial equipment exposed to saline, a satellite or satellite component, or heating, ventilation, air-conditioning and refrigeration (HVACR) equipment.

### CROSS-REFERENCE TO RELATED APPLICATIONS

This application claims priority under 35 U.S.C. §119(e) to U.S. Provisional Patent Application Ser. No. 61/844,088 filed on Jul. 9, 2013.

### FIELD OF DISCLOSURE

The present disclosure generally relates to structures formed from lightweight and high-strength plated polymers for the fabrication of various industrial products. More specifically, the present disclosure relates to the use of plated polymers for the construction of various industrial products such as, but not limited to, nuclear waste equipment, nuclear waste containers, industrial equipment exposed to saline, satellites and satellite components, wind-turbine nacelles, wind-turbine blades, leaf springs, pulleys, impellers, gears, bearing balls, elevator structures, robotic components, and heating, ventilation, air-conditioning, and refrigeration (HVACR) equipment.

### BACKGROUND

Many engineers continue to seek high-strength and lightweight parts for various industrial applications such as, but not limited to, construction, automotive, and aerospace applications. Lightweight components may be desirable, for example, in some applications to provide favorable reductions in shipping costs or installation and repair costs. In addition, higher-strength components may exhibit enhanced performance characteristics such as stiffness, improved load capability, improved environmental durability, erosion resistance, and impact resistance. Polymeric materials may be attractive materials for component fabrication in a number of industries because they are lightweight and moldable into a range of complex shapes by conventional processes. While effective, parts formed from polymeric materials may be limited to relatively few structurally loaded applications as they may be less structurally capable than metallic components of similar geometry. In contrast, parts formed from metallic materials are strong and may be less prone to structural failure compared to similarly-dimensioned polymeric parts, but they may be too heavy for some weight-sensitive applications. Consequently, there is a need for parts having both lightweight and high-strength properties for a range of industrial applications.

### SUMMARY OF THE DISCLOSURE

In accordance with one aspect of the present disclosure, an industrial product is disclosed. The industrial product may comprise a polymer substrate formed in a shape of the industrial product, and a metallic plating layer plated on at least one surface of the industrial product.

In another refinement, the industrial product may be nuclear waste equipment.

In another refinement, the nuclear waste equipment may be a nuclear waste container having an inner cavity configured to contain nuclear waste.

In another refinement, the metallic plating layer may contain at least one radiation-shielding metal.

In another refinement, the industrial product may be industrial equipment configured to be exposed to saline.

In another refinement, the industrial equipment may be a submersible vehicle.

In another refinement, the industrial equipment may be selected from a group consisting of a submersible vehicle, desalination equipment, a vehicle structural frame, a hull structural frame, optical viewing equipment for an unmanned underwater vehicle, an unmanned underwater vehicle control device, and an unmanned underwater vehicle manipulation arm.

In another refinement, the industrial product may be a satellite component.

In another refinement, the industrial product may be a satellite.

In another refinement, the industrial product may be HVACR equipment.

In another refinement, the HVACR equipment may comprise a heater, a hot water heater, an air conditioning unit, a refrigerator, or a component contained within any of the foregoing.

In another refinement, the component may be selected from a group consisting of a heat exchanger, a pipe, a fitting, a fastener, a flange, a pump, a valve, a drain, a tank, and filtration equipment.

In another refinement, the metallic plating layer may consist of titanium.

In accordance with another aspect of the present disclosure, an industrial product is disclosed. The industrial product may include a polymer substrate formed in a shape of the industrial product, and a metallic plating layer deposited on at least one surface of the polymer substrate. The industrial product may be fabricated by a method comprising: 1) forming the polymer substrate in the shape of the industrial product, 2) activating and metallizing the at least one surface of the polymer substrate, and 3) depositing the metallic plating layer on the at least one surface of the polymer substrate to provide the industrial product.

In another refinement, the industrial product may be nuclear waste equipment.

In another refinement, the industrial product may be industrial equipment configured to be exposed to saline.

In another refinement, the industrial product may be a satellite component.

In another refinement, the industrial product may be HVACR equipment.

In accordance with another aspect of the present disclosure, a method for fabricating an industrial product is disclosed. The method may comprise: 1) forming a polymer substrate in a shape of the industrial product, 2) activating and metallizing at least one surface of the polymer substrate, and 3) depositing a metallic plating layer on the at least one surface of the polymer substrate to provide the industrial product.

In another refinement, the method may further comprise: 1) forming the polymer substrate in segments, 2) activating and metallizing selected surfaces of the segments, and 3) bonding the activated and metallized surfaces of the segments by transient liquid phase bonding.

These and other aspects and features of the present disclosure will be more readily understood when read in conjunction with the accompanying drawings.

### BRIEF DESCRIPTION OF THE DRAWINGS

FIG. 1 is a perspective view of a plated polymeric nuclear waste equipment, constructed in accordance with the present disclosure.

FIG. 2 is a cross-sectional view of the plated polymeric nuclear waste equipment of FIG. 1 taken along the line 2-2 of FIG. 1, constructed in accordance with the present disclosure.

FIG. 3 is a flowchart illustrating methods for fabricating the plated polymeric nuclear waste equipment, in accordance with the present disclosure.

FIG. 4 is a perspective view of a plated polymeric industrial equipment as a plated polymeric submersible vehicle, constructed in accordance with the present disclosure.

FIG. 5 is a cross-sectional view of the plated polymeric industrial equipment of FIG. 4 taken along the line 5-5 of FIG. 4, constructed in accordance with the present disclosure.

FIG. 6 is a flowchart illustrating methods for fabricating the plated polymeric industrial equipment, in accordance with the present disclosure.

FIG. 7 is a side view of a wind turbine including a plated polymeric nacelle, constructed in accordance with the present disclosure.

FIG. 8 is a cross-sectional view of the plated polymeric nacelle of FIG. 7 taken along the line 8-8 of FIG. 7, constructed in accordance with the present disclosure.

FIG. 9 is a flowchart illustrating methods for fabricating the plated polymeric nacelle, in accordance with the present disclosure.

FIG. 10 is a perspective view of a wind turbine having plated polymeric blades, constructed in accordance with the present disclosure.

FIG. 11 is a cross-sectional view of a plated polymeric blade of FIG. 10 taken along the line 11-11 of FIG. 10, constructed in accordance with the present disclosure.

FIG. 12 is a cross-sectional view similar to FIG. 11, but with the plated polymeric blade being filled with a polymeric substrate, constructed in accordance with the present disclosure.

FIG. 13 is a flowchart illustrating methods for fabricating the plated polymeric blade, in accordance with the present disclosure.

FIG. 14 is a perspective view of a satellite having a plated polymeric frame, constructed in accordance with the present disclosure.

FIG. 15 is a cross-sectional view of the plated polymeric frame of FIG. 14 taken along the line 15-15 of FIG. 14, constructed in accordance with the present disclosure.

FIG. 16 is a flowchart illustrating steps involved in the fabrication of the plated polymeric frame, in accordance with the present disclosure.

FIG. 17 is a perspective view of a wheeled vehicle having plated polymeric leaf springs, constructed in accordance with the present disclosure.

FIG. 18 is a perspective view of a plated polymeric leaf spring in isolation, constructed in accordance with the present disclosure.

FIG. 19 is a cross-sectional view of the plated polymeric leaf spring of FIG. 18 taken along the line 19-19 of FIG. 18, constructed in accordance with the present disclosure.

FIG. 20 is a flowchart illustrating methods for the fabrication of the plated polymeric leaf spring, in accordance with the present disclosure.

FIG. 21 is a perspective view of a plated polymeric pulley, constructed in accordance with the present disclosure.

FIG. 22 is a cross-sectional view of the plated polymeric pulley of FIG. 21 taken along the line 22-22 of FIG. 21, constructed in accordance with the present disclosure.

FIG. 23 is a flowchart illustrating a method for fabricating the plated polymeric pulley, in accordance with the present disclosure.

FIG. 24 is a perspective view of a plated polymeric impeller, constructed in accordance with the present disclosure.

FIG. 25 is a cross-sectional view of the plated polymeric impeller of FIG. 24 taken along the line 25-25 of FIG. 24, constructed in accordance with the present disclosure.

FIG. 26 is a flowchart illustrating methods for fabricating the plated polymeric impeller, in accordance with the present disclosure.

FIG. 27 is a front view of a plated polymeric gear, constructed in accordance with the present disclosure.

FIG. 28 is a cross-sectional view of the plated polymeric gear of FIG. 27 taken along the line 28-28 of FIG. 27, constructed in accordance with the present disclosure.

FIG. 29 is a flowchart illustrating methods for fabricating the plated polymeric gear, in accordance with the present disclosure.

FIG. 30 is a side view of plated polymeric casting dies, constructed in accordance with the present disclosure.

FIG. 31 is a cross-sectional view of the plated polymeric casting dies of FIG. 30 taken along the line 31-31 of FIG. 30, constructed in accordance with the present disclosure.

FIG. 32 is a flowchart illustrating methods for fabricating the plated polymeric casting dies, in accordance with the present disclosure.

FIG. 33 is a front view of a plated bearing ball, constructed in accordance with the present disclosure.

FIG. 34 is a cross-sectional view of the plated bearing ball of FIG. 33 taken along the line 34-34 of FIG. 33, constructed in accordance with the present disclosure.

FIG. 35 is a cross-sectional view similar to FIG. 34, but having an internal support structure, constructed in accordance with the present disclosure.

FIG. 36 is a flowchart illustrating steps for fabricating the plated bearing ball, in accordance with a method of the present disclosure.

FIG. 37 is a side view of a plated polymeric compliant mechanism, constructed in accordance with the present disclosure.

FIG. 38 is a cross-sectional view of the plated polymeric compliant mechanism of FIG. 37 taken along the line 38-38 of FIG. 37, constructed in accordance with the present disclosure.

FIG. 39 is a flowchart illustrating methods for fabricating the plated polymeric compliant mechanism, in accordance with the present disclosure.

FIG. 40 is a perspective view of a plated polymeric heating, ventilation, air conditioning, and refrigeration (HVACR) equipment, constructed in accordance with the present disclosure.

FIG. 41 is a cross-sectional view of the plated polymeric HVACR equipment of FIG. 40 taken along the line 41-41 of FIG. 40, constructed in accordance with the present disclosure.

FIG. 42 is a flowchart illustrating methods for fabricating the plated polymeric HVACR equipment, in accordance with the present disclosure.

FIG. 43 is a perspective view of a plated polymeric elevator structure as elevator doors, constructed in accordance with the present disclosure.

FIG. 44 is a cross-sectional view of an elevator door of FIG. 43 taken along the line 44-44 of FIG. 43, constructed in accordance with the present disclosure.

FIG. 45 is a flow chart illustrating methods for fabricating the plated polymeric elevator structure, in accordance with the present disclosure.

FIG. 46 is a side view of a plated polymeric robotic component, constructed in accordance with the present disclosure.

FIG. 47 is a cross-sectional view of the plated polymeric robotic component of FIG. 46 taken along the line 47-47 of FIG. 46, constructed in accordance with the present disclosure.

FIG. 48 is a flowchart illustrating methods for fabricating the plated polymeric robotic component, in accordance with the present disclosure.

It should be understood that the drawings are not necessarily drawn to scale and that the disclosed embodiments are sometimes illustrated diagrammatically and in partial views. In certain instances, details which are not necessary for an understanding of this disclosure or which render other details difficult to perceive may have been omitted. It should be understood, of course, that this disclosure is not limited to the particular embodiments disclosed herein.

### DETAILED DESCRIPTION

Plated Polymeric Nuclear Waste Equipment

Nuclear waste equipment may be single-use articles employed for the handling, transfer, and storage of nuclear waste produced as by-products of nuclear power generation or from other applications such as research or medicine. As nuclear waste is hazardous to most forms of life and the environment, the construction of structurally robust nuclear waste equipment (i.e., containers, etc.) is crucial for both public and environmental health and safety. However, current nuclear waste equipment may be heavy in some cases, which may cause difficulties in handling as well as increases in transportation costs for delivery of the nuclear waste to a remediation site. Clearly, there is a need for lighter weight constructions for nuclear waste equipment.

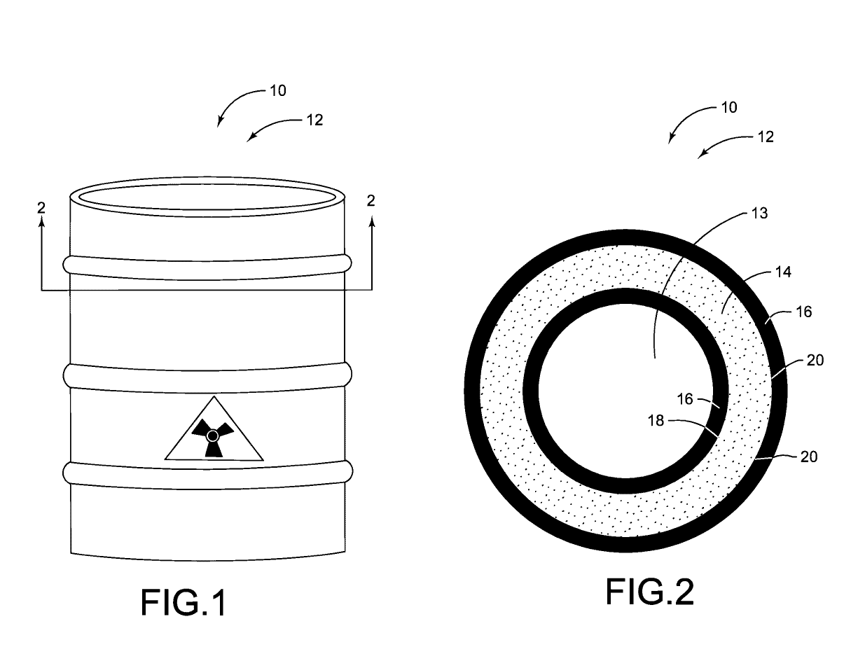

Referring now to the drawings, and with specific reference to FIGS. 1 and 2, a plated polymeric nuclear waste equipment 10 is shown. The plated polymeric nuclear waste equipment 10 may be used for storage, transfer, and/or handling of nuclear waste. As a non-limiting example, it may be a nuclear waste container 12 having an inner cavity 13 for containing nuclear waste, as shown. Importantly, by virtue of the plated polymeric construction of the nuclear waste equipment 10 (see further details below), it may be high in structural strength but lighter in weight than similarly dimensioned nuclear waste equipment formed from traditional materials and processes.

The plated polymeric construction of the nuclear waste equipment 10 is best shown in FIG. 2. In particular, the nuclear waste equipment 10 may consist of a polymeric substrate 14 plated on one or more of its surfaces with one or more metallic plating layers 16. The polymeric substrate 14 may be formed in the shape of the desired nuclear waste equipment, such as the nuclear waste container 12 shown. As one possibility, the polymeric substrate 14 may be plated with one or more metallic plating layers 16 both on its interior surface 18 and on its exterior surface 20, as shown. As other possibilities, the polymeric substrate 14 may have one or more metallic plating layers 16 only on its interior surface 18 (which may be in contact with the nuclear waste) or only on its exterior surface 20. Alternatively, one or more metallic plating layers 16 may be deposited on selected regions of either or both of the interior surface 18 and the exterior surface 20 of the polymeric substrate 14.

The polymeric substrate 14 may be formed from a thermoplastic material or a thermoset material, either of which may be optionally reinforced with one or more types of reinforcing materials such as, but not limited to, carbon or glass. Suitable thermoplastic materials may include, but are not limited to, polyetherimide (PEI), thermoplastic polyimide, polyether ether ketone (PEEK), polyether ketone ketone (PEKK), polysulfone, polyamide, polyphenylene sulfide, polyester, polyimide, and combinations thereof. Suitable thermoset materials may include, but are not limited to, condensation polyimides, addition polyimides, epoxy cured with aliphatic and/or aromatic amines and/or anhydrides, cyanate esters, phenolics, polyesters, polybenzoxazine, polyurethanes, polyacrylates, polymethacrylates, silicones (thermoset), and combinations thereof. The thickness of the polymeric substrate 14 may vary depending on the molding process used to form the polymeric substrate. For example, the thickness of the polymeric substrate 14 may range from about 0.05 inches (about 1.27 mm) to about 0.25 inches (about 6.35 mm) if it is formed by injection molding, whereas its thickness may range from about 0.05 inches (about 1.27 mm) to about two inches (about 51 mm) if it is formed by compression molding.

The metallic plating layer(s) 16 may consist of one or more metals such as, but not limited to, nickel, lead, cobalt, copper, iron, gold, silver, palladium, rhodium, chromium, zinc, tin, cadmium, and alloys with any of the foregoing elements comprising at least 50 wt. % of the alloy, and combinations thereof. Notably, at least one of the metallic plating layers 16 may contain at least one radiation-shielding metal, such as lead. The metallic plating layer 16 may have an average thickness in the range of about 0.010 inches (about 0.25 mm) to about 0.500 inches (about 12.7 mm), with localized thicknesses in the range of about 0.005 inches (about 0.127 mm) to about 1.000 inches (about 25.4 mm), but other metallic plating layer thicknesses may also be used. This range of metallic plating layer thicknesses may provide the nuclear waste equipment 10 with resistance to erosion, impact, and/or foreign-object damage.

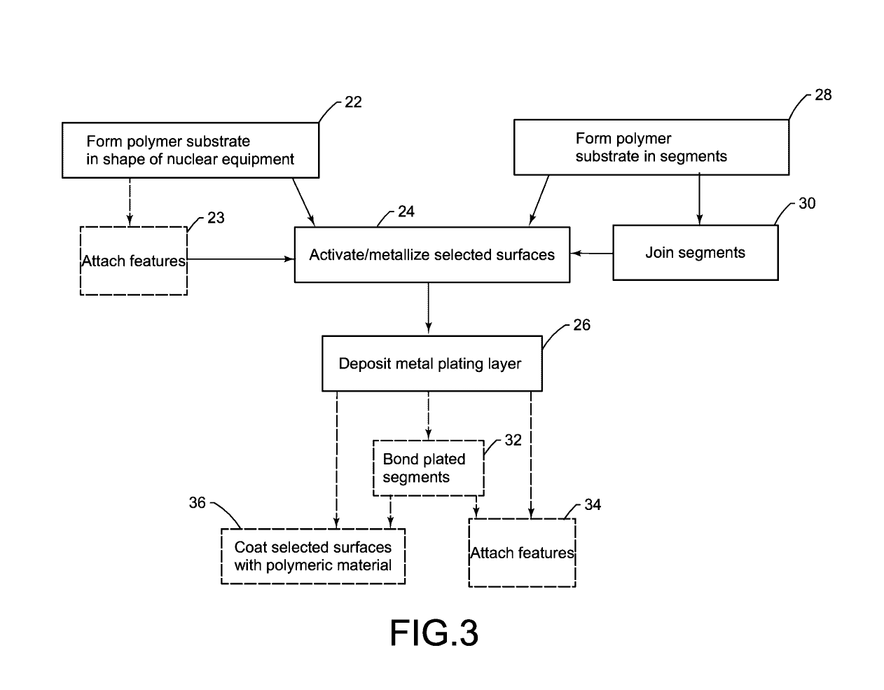

Different methods for fabricating the plated polymeric nuclear waste equipment 10 are shown in FIG. 3. Beginning with a first block 22, the polymeric substrate 14 may be formed from selected thermoplastic materials or thermoset materials (with optional reinforcement) in a shape of the desired nuclear waste equipment (e.g., nuclear waste container 12). It may be formed in the desired shape using a range of polymer molding processes apparent to those skilled in the art such as, but not limited to, injection molding, compression molding, blow molding, additive manufacturing (liquid bed, powder bed, deposition), or composite layup (autoclave, compression, or liquid molding). To simplify the mold tooling, additional features such as mounting features (e.g., flanges or bosses) may be attached to the polymeric substrate after the block 22, according to an optional block 23. Such features may be attached by bonding using a suitable adhesive. Following the block 22 (or the optional block 23), interior or exterior surfaces of the polymeric substrate 14 which are selected for plating with the metallic plating layer 16 may be suitably activated and metallized according to a next block 24. Activation and metallization of the selected surfaces of the polymeric substrate 14 may be carried out using well-established methods in the industry and may result in metallic (conductive) surfaces being formed on the treated surfaces of the polymeric substrate 14, allowing the subsequent deposition of the metallic plating layer 16 thereon.

Following the block 24, one or more metallic plating layers 16 may be deposited on the activated/metallized surfaces of the polymeric substrate 14 according to a next block 26. Deposition of the metallic plating layer(s) 16 may be carried out using metal deposition methods apparent to those skilled in the art such as, but not limited to, electroplating, electroless plating, or electroforming. If desired, masking of selected surfaces of the polymeric substrate 14 may be employed to yield different thicknesses of the metallic plating layer or no plating on the selected areas, as will be understood by those skilled in the art. In addition, if desired, a customized metallic plating layer thickness profile on the surfaces of the polymeric substrate 14 may be achieved using tailored racking tools (e.g., shields, thieves, conformal anodes, etc.), as will be understood by those skilled in the art. Customization of the thickness profile of the metallic plating layer(s) 16 by masking and/or by the use of tailored racking tools may allow for optimization of desired properties (e.g., fire resistance, structural support, surface characteristics, etc.) of the nuclear waste equipment 10, without adding undue weight to the nuclear waste equipment to accommodate each of these properties.

As an alternative method to fabricate the nuclear waste equipment 10, the polymeric substrate 14 may be formed in two or more segments according to a block 28, as shown. The segments of the polymeric substrate 14 may be formed in desired shapes from the thermoplastic or thermoset materials (with optional reinforcement) using one or more of the polymer molding processes described above. Following the block 28, the polymer segments may be joined to form the full-scale polymeric substrate 14, according to a next block 30, as shown. Joining of the polymer segments may be achieved using conventional processes such as, but not limited to, welding (ultrasonic, laser, friction, friction-stir, traditional, etc.), adhesive bonding, or formation of mitered joints (with or without adhesive), as will be apparent to those skilled in the art. Upon completion of the block 30, selected surfaces of the polymeric substrate 14 may be suitably activated and metallized (block 24) and one or more metallic plating layers 16 may be deposited on the activated/metallized surfaces (block 26), as described above.

As another alternative fabrication method, selected surfaces of each of the polymer segments formed by the block 28 may be activated and metallized (block 24) and one or more metallic plating layers 16 may be deposited on the activated/metallized surfaces of each of the polymer segments (block 26). The plated segments may then be bonded together to form the full-scale nuclear waste equipment 10 according to the block 32, as shown. Bonding of the plated segments may be achieved using transient liquid phase (TLP) bonding, as will be understood by those skilled in the art.

Once the plated polymeric nuclear waste equipment 10 is formed by one of the above-described methods, if desired, it may be further processed according to the optional blocks 34 and/or 36, as shown. For example, additional features (e.g., bosses, inserts, etc.) may be attached to the nuclear waste equipment 10 according to the optional block 34. Attachment of such additional features may be achieved using a suitable adhesive, a fastener (e.g., rivets, bolts, etc.), or another bonding process. In addition, selected surfaces of the nuclear waste equipment 10 may be coated with one or more polymeric materials according to the optional block 36. Coating of the nuclear waste equipment 10 may be achieved using conventional processes such as, but not limited to, spray coating or dip coating. In addition, coating of the nuclear waste equipment 10 with the polymeric material may provide a lightweight, stiff, and strong polymeric-appearing (non-conductive) product.

From the foregoing, it can therefore be seen that the present disclosure can find industrial applicability in many situations such as, but not limited to, situations requiring lightweight equipment for storing, transporting, or handling of nuclear waste. The plated polymeric nuclear waste equipment as disclosed herein may provide lightweight and high-strength alternatives for existing nuclear waste equipment formed from traditional materials and processes. The technology as disclosed herein may find wide industrial applicability in a wide range of areas such as the armed forces, power generation, research, medicine, and governmental agencies.

Plated Polymeric Industrial Equipment Exposed to Saline

Industrial equipment exposed to high salinity environments (e.g., marine environments, etc.) may include structures such as, but not limited to, submersible vehicles and desalination equipment. Such industrial equipment may be susceptible to corrosion which could cause the equipment to wear down over time. In addition, some submersible vehicles are formed from heavy materials which could lead to lower than desired payload capacities (i.e., the weight that the vehicle can carry) as well as shorter operational time periods. Even further, some desalination processes performed by desalination equipment may produce large quantities of reaction byproducts such as heavy metals due to corrosion. Clearly, there is a need for lighter weight and more corrosion-resistant constructions for industrial equipment exposed to high salinity environments.

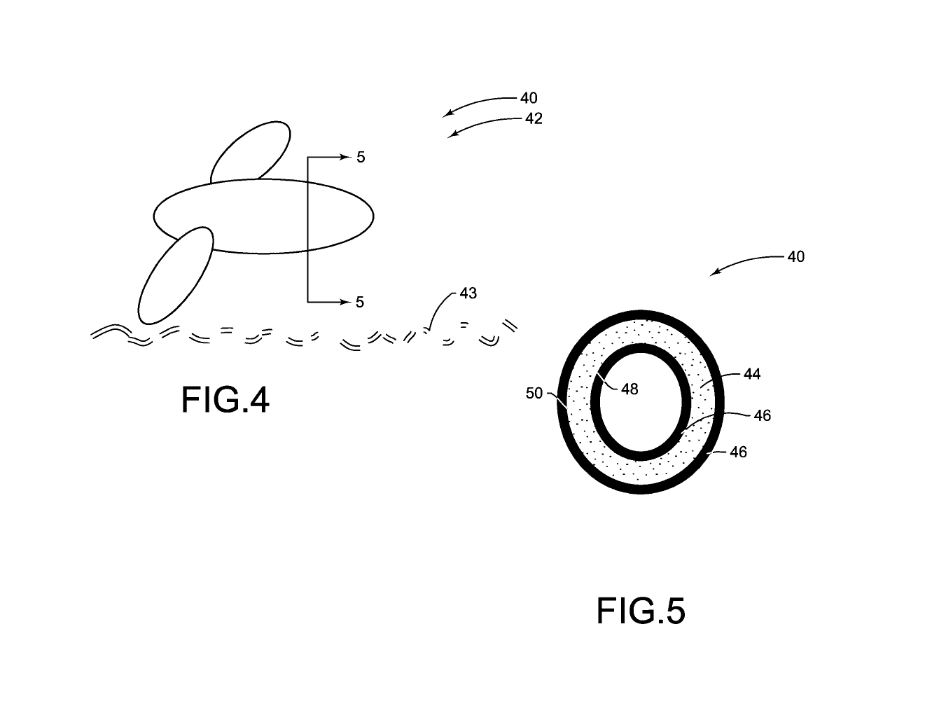

Referring now to FIGS. 4 and 5, a plated polymeric industrial equipment 40 is shown. The plated polymeric industrial equipment 40 may be any type of industrial equipment which is exposed to saline environments (e.g., marine environments, etc.). As a non-limiting example, the plated polymeric industrial equipment 40 may be a submersible vehicle 42 designed for submersion in seawater 43, as shown. However, the plated polymeric industrial equipment 40 may be other types of industrial equipment such as, but not limited to, desalination equipment, vehicle/hull structural frames, optical viewing/recording equipment for unmanned underwater vehicles, unmanned underwater vehicle control devices, unmanned underwater vehicle manipulation arms, or any other type of equipment exposed to saline environments. Importantly, by virtue of the plated polymeric construction of the industrial equipment 40, it may be lightweight and exhibit improved corrosion resistance over many current systems used in saline environments. The lightweight and corrosion-resistant properties of the industrial equipment 40 may lead to improved vehicle payload capacity and/or longer operational periods (if the industrial equipment is the submersible vehicle 42) or reduced production of heavy metal byproducts from corrosion (if the industrial equipment is desalination equipment).

The plated polymeric construction of the industrial equipment 40 is best shown in the cross-sectional view of FIG. 5. In particular, FIG. 5 shows the walls of the submersible vehicle 42 with internal features (and the back wall) removed for clarity purposes. The industrial equipment 40 may consist of a polymeric substrate 44 plated on one or more of its surfaces with one or more metallic plating layers 46, as shown. The polymeric substrate 44 may be formed in the shape of the desired industrial equipment, such as the walls of the submersible vehicle 42 shown. As one possibility, the polymeric substrate 44 may be plated with one or more metallic plating layers 46 on both its interior surface 48 and its exterior surface 50, as shown. As alternative possibilities, the polymeric substrate 44 may have one or more metallic plating layers 46 only on its exterior surface 50 or only on its interior surface 48, depending on which surfaces may be in contact with the saline environment. As another alternative possibility, one or more metallic plating layers 46 may be deposited only on selected regions of either or both of the interior surface 48 and the exterior surface 50 of the polymeric substrate 44.

The polymeric substrate 44 may be formed from a thermoplastic material or a thermoset material, either of which may be optionally reinforced with one or more types of reinforcing materials such as, but not limited to, carbon or glass. Suitable thermoplastic materials may include, but are not limited to, polyetherimide (PEI), thermoplastic polyimide, polyether ether ketone (PEEK), polyether ketone ketone (PEKK), polysulfone, polyamide, polyphenylene sulfide, polyester, polyimide, and combinations thereof. Suitable thermoset materials may include, but are not limited to, condensation polyimides, addition polyimides, epoxy cured with aliphatic and/or aromatic amines and/or anhydrides, cyanate esters, phenolics, polyesters, polybenzoxazine, polyurethanes, polyacrylates, polymethacrylates, silicones (thermoset), and combinations thereof.

The metallic plating layer(s) 46 may consist of one or more metals selected from nickel, cobalt, copper, iron, gold, silver, palladium, rhodium, chromium, zinc, tin, cadmium, and alloys with any of the foregoing elements comprising at least 50 wt. % of the alloy, and combinations thereof. The metallic plating layer 46 may have an average thickness in the range of about 0.004 inches (about 0.102 mm) to about 0.040 inches (about 1.02 mm), with localized thicknesses in the range of about 0.001 inches (about 0.025 mm) to about 0.050 inches (about 1.27 mm), but other metallic plating layer thicknesses may also be used. This range of metallic plating layer thicknesses may provide the industrial equipment 40 with resistance to erosion, impact, and/or foreign-object damage. In addition, this thickness range may also provide the option to finish the surfaces of the industrial equipment 40 more aggressively to meet tight tolerances or surface finish requirements.

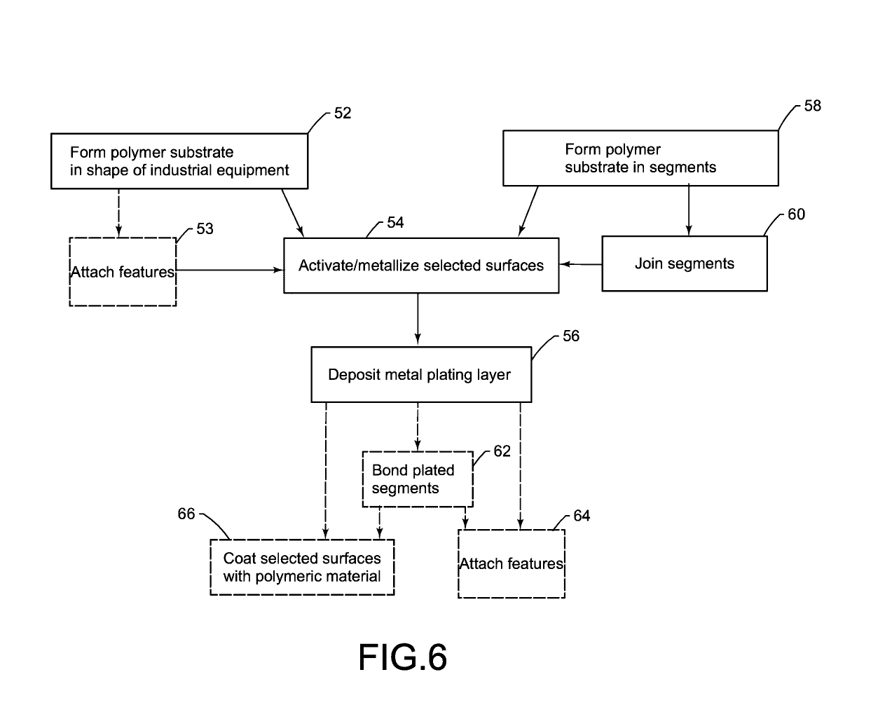

Various methods for fabricating the plated polymeric industrial equipment 40 are shown in FIG. 6. Beginning with a first block 52, the polymeric substrate 44 may be formed from selected thermoplastic materials or thermoset materials (with optional reinforcement) in a shape of the desired industrial equipment (e.g., the walls of the submersible vehicle 42). It may be formed in the desired shape using a range of polymer molding processes apparent to those skilled in the art such as, but not limited to, injection molding, compression molding, blow molding, additive manufacturing (liquid bed, powder bed, deposition), or composite layup (autoclave, compression, or liquid molding). To simplify the mold tooling, additional features (e.g., mounting features, flanges, bosses, etc.) may be attached to the polymeric substrate 44 after the block 52, according to an optional block 53. Such features may be attached by bonding using a suitable adhesive. Following the block 52 (or the optional block 53), interior or exterior surfaces of the polymeric substrate 44 which are selected for plating with the metallic plating layer 46 may be suitably activated and metallized according to a next block 54. Activation and metallization of the selected surfaces of the polymeric substrate 44 may be carried out using well-established methods in the industry and may result in metallic (conductive) surfaces being formed on the treated surfaces of the polymeric substrate 44, allowing the subsequent deposition of the metallic plating layer(s) 46 thereon.

Following the block 54, one or more metallic plating layers 46 may be deposited on the activated/metallized surfaces of the polymeric substrate 44 according to a next block 56. Deposition of the metallic plating layer(s) 46 may be carried out using metal deposition methods apparent to those skilled in the art such as, but not limited to, electroplating, electroless plating, or electroforming. If desired, masking of selected surfaces of the polymeric substrate 44 may be employed to yield different thicknesses of the metallic plating layer 46 or no plating on the selected areas, as will be understood by those skilled in the art. In addition, if desired, a customized metallic plating layer thickness profile on the surfaces of the polymeric substrate 44 may be achieved using tailored racking tools (e.g., shields, thieves, conformal anodes, etc.), as will be understood by those skilled in the art. Customization of the thickness profile of the metallic plating layer(s) 46 by masking and/or by the use of tailored racking tools may allow for optimization of desired properties (e.g., structural support, surface characteristics, etc.) of the industrial equipment 40, without adding undue weight to the industrial equipment 40 to accommodate each of the desired properties.

As an alternative method to fabricate the industrial equipment 40, the polymeric substrate 44 may be formed in two or more segments according to a block 58, as shown. The segments of the polymeric substrate 44 may be formed in desired shapes from thermoplastic or thermoset materials (with optional reinforcement) using one or more of the polymer molding processes described above. Following the block 58, the polymer segments may be joined to form the full-scale polymeric substrate 44, according to a next block 60, as shown. Joining of the polymer segments may be achieved using conventional processes such as, but not limited to, welding (ultrasonic, laser, friction, friction-stir, traditional, etc.), adhesive bonding, or formation of mitered joints (with or without adhesive), as will be apparent to those skilled in the art. Upon completion of the block 60, selected surfaces of the polymeric substrate 44 may then be suitably activated and metallized (block 54) and one or more metallic plating layers 46 may be deposited on the activated/metallized surfaces (block 56), as described above.

As another alternative fabrication method, selected surfaces of each of the polymer segments formed by the block 58 may be activated and metallized (block 54) and one or more metallic plating layers 16 may be deposited on the activated/metallized surfaces of the polymer segments (block 56). The plated segments may then be bonded together to form the full-scale industrial equipment 40 according to the block 62, as shown. Bonding of the plated segments may be achieved using transient liquid phase (TLP) bonding, as will be understood by those skilled in the art.

Once the plated polymeric industrial equipment 40 is formed by one of the above-described methods, it may be further processed according to the optional blocks 64 and/or 66, as shown. For example, additional features (e.g., bosses, inserts, etc.) may be attached to the industrial equipment 40 according to the optional block 64. Attachment of such additional features may be achieved using a suitable adhesive, a fastener (e.g., rivets, bolts, etc.), or another bonding process. In addition, selected surfaces of the industrial equipment 40 may be coated with one or more polymeric materials according to the optional block 66. Coating of the industrial equipment 40 with the polymeric material may be achieved using conventional processes such as, but not limited to, spray coating or dip coating. In addition, coating of the industrial equipment 40 with the polymeric material may provide a lightweight, stiff, and strong polymeric-appearing (non-conductive) product.

It is further noted that the plated polymeric industrial equipment 40 may also be a composite of plated polymeric components which are joined, bonded, and/or attached to components formed from other materials. For example, the industrial equipment 40 may consist of a shaft formed from a plated polymer which is attached to a blade formed from a composite material or another type of material (polymeric, metallic, etc.).

From the foregoing, it can therefore be seen that the present disclosure can find industrial applicability in many situations such as, but not limited to, situations which may benefit from lightweight components having improved resistance to corrosion in saline environments. The plated polymeric industrial equipment as disclosed herein may provide a lightweight, high-strength, and corrosion-resistant alternative for existing industrial equipment exposed to saline environments (e.g., marine environments, etc.). Furthermore, the plated polymeric construction of the industrial equipment may lead to advantageous cost reductions and reduced environmental concerns associated with the release of heavy metal byproducts due to corrosion. The technology as disclosed herein may find wide industrial applicability in a wide range of areas such as submersible vehicles and desalination equipment.

Plated Polymeric Wind-Turbine Nacelles

Wind turbines convert kinetic energy from the wind into mechanical energy and are valuable alternative power-generation devices that produce clean and renewable energy. Wind turbines may generally consist of rotor blades and a nacelle connected to a pole that maintains the rotor blades and the nacelle at a given height above the ground where there is more wind energy to be harnessed. The wind turbine nacelle is a large structure (approximately bus-size or larger) and houses mechanical and electrical equipment necessary to translate power such as gears, shafts, a generator, and electronics. The wind-turbine nacelle is traditionally composed of a metallic frame with a foam core outer covering. While effective, such nacelle structures may be heavy in some cases, which may lead to significant challenges and costs related to their installation at elevated heights. As reductions in part weight and costs are important issues in alternative energy, there is clearly a need for lighter weight constructions for wind turbine nacelles.

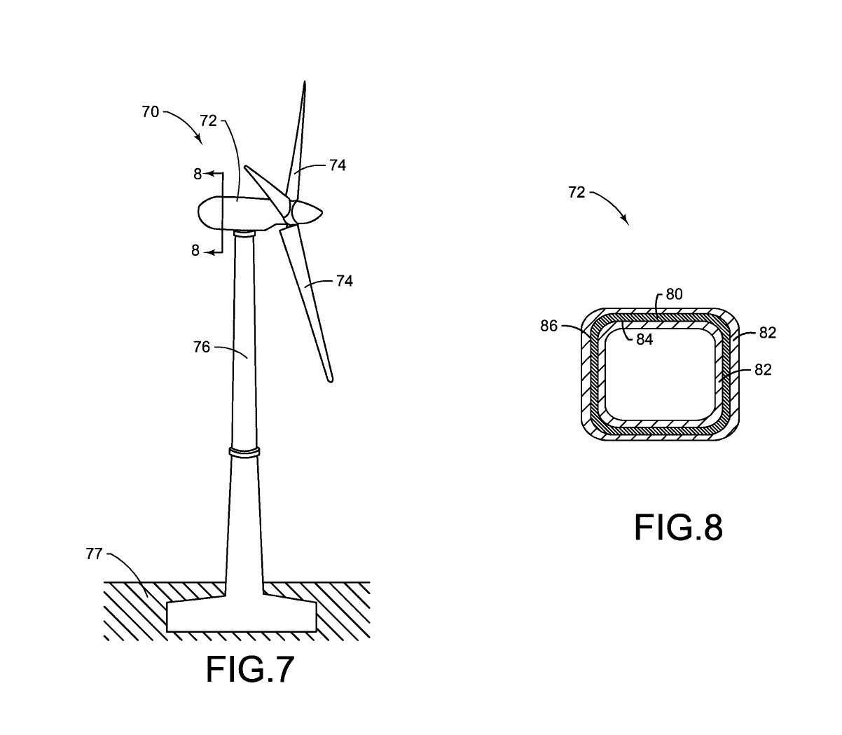

Referring now to FIGS. 7 and 8, a wind turbine 70 including a plated polymeric nacelle 72 is shown. The wind turbine 70 may be involved in converting wind energy into mechanical energy. In addition to the nacelle 72, the wind turbine 70 may further include rotor blades 74 and a pole 76 which may elevate the nacelle 72 and the rotor blades 74 at a given height above a support surface 77, as shown, as well as several other structures and features apparent to those skilled in the art. The plated polymeric nacelle 72 may house several mechanical and electrical features necessary for power translation such as, but not limited to, gears, shafts, a generator, and electronic equipment. Importantly, the plated polymeric nacelle 72 may be lighter in weight than similarly dimensioned wind-turbine nacelles formed from traditional materials and processes. The lighter-weight construction of the plated polymeric nacelle 72 may lead to advantageous reductions in costs for installation and/or repair of the nacelle.

The plated polymeric construction of the nacelle 72 is best shown in the cross-sectional view of FIG. 8. In particular, FIG. 8 shows the walls of the nacelle 72 with internal features and the back wall removed for clarity purposes. The plated polymeric nacelle 72 may consist of a polymeric substrate 80 plated on one or more of its surfaces with one or more metallic plating layers 82, as shown. The polymeric substrate 80 may be formed in the shape of the walls of the desired nacelle, which may deviate from the structure shown in FIG. 8. As one possibility, the polymeric substrate 80 may be plated with one or more metallic plating layers 82 on both its interior surface 84 and its exterior surface 86, as shown. As additional possibilities, the polymeric substrate 80 may have one or more metallic plating layers 82 only on its exterior surface 86 or only on its interior surface 84, depending on the design requirements of the nacelle. As another alternative, one or more metallic plating layers 82 may be deposited only on selected regions of either or both of the interior surface 84 and the exterior surface 86 of the polymeric substrate 80.

The polymeric substrate 80 may be formed from a thermoplastic material or a thermoset material, either of which may be optionally reinforced with one or more types of reinforcing materials such as, but not limited to, carbon or glass. Suitable thermoplastic materials may include, but are not limited to, polyetherimide (PEI), thermoplastic polyimide, polyether ether ketone (PEEK), polyether ketone ketone (PEKK), polysulfone, polyamide, polyphenylene sulfide, polyester, polyimide, and combinations thereof. Suitable thermoset materials may include, but are not limited to, condensation polyimides, addition polyimides, epoxy cured with aliphatic and/or aromatic amines and/or anhydrides, cyanate esters, phenolics, polyesters, polybenzoxazine, polyurethanes, polyacrylates, polymethacrylates, silicones (thermoset), and combinations thereof. The thickness of the polymeric substrate 80 may vary depending on the molding process used to form the polymeric substrate. For example, the thickness of the polymeric substrate 80 may range from about 0.050 inches (about 1.27 mm) to about 0.25 inches (about 6.35 mm) if it is formed by injection molding, with localized areas ranging up to about 0.5 inches (about 13 mm). In contrast, its thickness may range from about 0.050 inches (about 1.27 mm) to about two inches (about 51 mm) if it is formed by compression molding.

The metallic plating layer(s) 82 may consist of one or more metals such as, but not limited to, nickel, cobalt, copper, iron, gold, silver, palladium, rhodium, chromium, zinc, tin, cadmium, and alloys with any of the foregoing elements comprising at least 50 wt. % of the alloy, and combinations thereof. The metallic plating layer 82 may have an average thickness in the range of about 0.004 inches (about 0.0.102 mm) to about 0.150 inches (about 3.81 mm), with localized thicknesses in the range of about 0.001 inches (about 0.025 mm) to about 0.250 inches (about 6.35 mm). This range of metallic plating layer thicknesses may provide the nacelle 72 with resistance to erosion, impact, and/or foreign-object damage. In addition, the thickness range may also provide the option to finish the surfaces of the nacelle 72 more aggressively to meet tight tolerances or surface finish requirements.

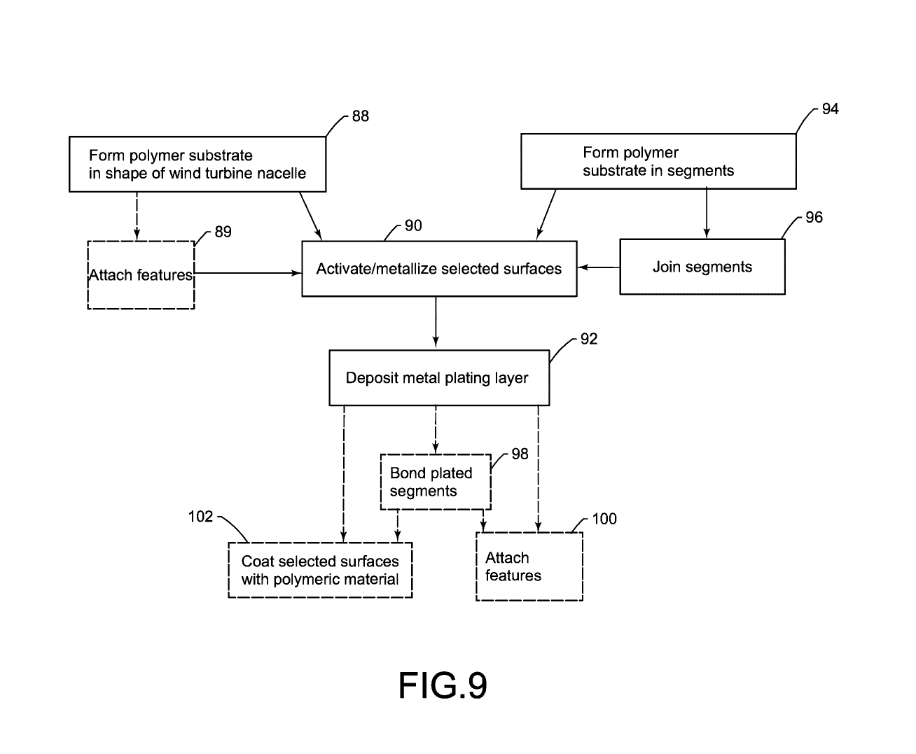

Various methods for fabricating the plated polymeric nacelle 72 are shown in FIG. 9. Beginning with a first block 88, the polymeric substrate 80 may be formed from selected thermoplastic materials or thermoset materials (with optional reinforcement) in a shape of the walls of the desired wind turbine nacelle. It may be formed in the desired shape using a range of polymer molding processes apparent to those skilled in the art such as, but not limited to, injection molding, compression molding, blow molding, additive manufacturing (liquid bed, powder bed, deposition), or composite layup (autoclave, compression, or liquid molding). To simplify the mold tooling, additional features (e.g., mounting features, flanges, bosses, etc.) may be attached to the polymeric substrate 80 after the block 88, according to an optional block 89. Such features may be attached by bonding using a suitable adhesive. Following the block 88 (or the optional block 89), interior or exterior surfaces of the polymeric substrate 80 which are selected for plating with the metallic plating layer 82 may be suitably activated and metallized according to a next block 90. Activation and metallization of the selected surfaces of the polymeric substrate 80 may be carried out using well-established methods in the industry and may result in metallic (conductive) surfaces being formed on the treated surfaces of the polymeric substrate 80, allowing the subsequent deposition of the metallic plating layer(s) 82 thereon.

Following the block 90, one or more metallic plating layers 82 may be deposited on the activated/metallized surfaces of the polymeric substrate 80 according to a next block 92. Deposition of the metallic plating layer(s) 82 may be carried out using metal deposition methods apparent to those skilled in the art such as, but not limited to, electroplating, electroless plating, or electroforming. If desired, masking of selected surfaces of the polymeric substrate 80 may be employed to yield different thicknesses of the metallic plating layer 82, or no plating on the selected areas, as will be understood by those skilled in the art. In addition, if desired, a customized metallic plating layer thickness profile on the surfaces of the polymeric substrate 80 may be achieved using tailored racking tools (e.g., shields, thieves, conformal anodes, etc.), as will be understood by those skilled in the art. Customization of the thickness profile of the metallic plating layer(s) 82 by masking and/or by the use of tailored racking tools may allow for optimization of desired properties (e.g., structural support, surface characteristics, etc.) of the nacelle 72, without adding undue weight to the nacelle 72 to accommodate each of the desired properties.

As an alternative method to fabricate the plated polymeric nacelle 72, the polymeric substrate 80 may be formed in two or more segments according to a block 94, as shown. The segments of the polymeric substrate 80 may be formed in desired shapes from thermoplastic or thermoset materials (with optional reinforcement) using one or more of the polymer molding processes described above. Following the block 94, the polymer segments may be joined to form the full-scale polymeric substrate 80, according to a next block 96, as shown. Joining of the polymer segments may be achieved using conventional processes such as, but not limited to, welding (ultrasonic, laser, friction, friction-stir, traditional, etc.), adhesive bonding, or formation of mitered joints (with or without adhesive), as will be apparent to those skilled in the art. Upon completion of the block 96, selected surfaces of the polymeric substrate 80 may then be suitably activated and metallized (block 90) and one or more metallic plating layers 82 may be deposited on the activated/metallized surfaces (block 92), as described above.

As another alternative fabrication method, selected surfaces of each of the polymer segments formed by the block 94 may be activated and metallized (block 90) and one or more metallic plating layers 82 may be deposited on the activated/metallized surfaces of the polymer segments (block 92), using the activation/metallization methods and metal deposition methods described above. The plated segments may then be bonded together to form the full-scale nacelle 72 according to the block 98, as shown. Bonding of the plated segments may be achieved using transient liquid phase (TLP) bonding, as will be understood by those skilled in the art.

Once the plated polymeric nacelle 72 is formed by one of the above-described methods, it may be further processed according to optional blocks 100 and/or 102, as shown. For example, additional features (e.g., bosses, inserts, etc.) may be attached to the nacelle 72 according to the optional block 100. Attachment of such additional features may be achieved using a suitable adhesive, a fastener (e.g., rivets, bolts, etc.), or another bonding process. In addition, selected surfaces of the nacelle 72 may be coated with one or more polymeric materials according to the optional block 102. Coating of the nacelle 72 with the polymeric material may be achieved using conventional processes such as, but not limited to, spray coating or dip coating. In addition, coating of the nacelle 72 with the polymeric material may provide a lightweight, stiff, and strong polymeric-appearing (non-conductive) product.

From the foregoing, it can therefore be seen that the present disclosure can find industrial applicability in many situations such as, but not limited to, situations which may benefit from lighter-weight wind-turbine nacelle constructions. The plated polymeric wind turbine nacelle as disclosed herein may provide lightweight alternatives for existing wind turbine nacelles formed from heavier metallic frames. The lighter weight construction of the plated polymeric nacelle may lead to advantageous reductions in installation and manufacturing costs for wind turbine nacelles. The technology as disclosed herein may find industrial applicability in the power generation industry.

Plated Polymeric Wind Turbine Blade

Wind turbines convert wind energy into electricity and are valuable alternative power generation devices. Wind turbines generally consist of blades connected to a hub as part of a nacelle assembly which rests at the top of a pole that holds the blades and nacelle assembly at a height above the ground sufficient to provide clearance for the blades. Wind turbine blades may have an aerodynamic tear-drop shape in cross-section designed to efficiently extract wind energy and drive an electric generator located inside of the nacelle assembly. Wind turbine blades are large structures (up to about 150 feet long) and, in some cases, may be challenging and expensive to install high above the ground on top of supporting pole structures. In addition, their ability to extract wind energy may be limited by the strength of the materials used in their construction. For example, wind turbine blades may be damaged by impact with objects in the environment (e.g., birds, etc.). As reductions in part weights, manufacturing costs, and installation costs are important issues in alternative energy, there is clearly a need for lightweight, high-strength material constructions for wind turbine blades.

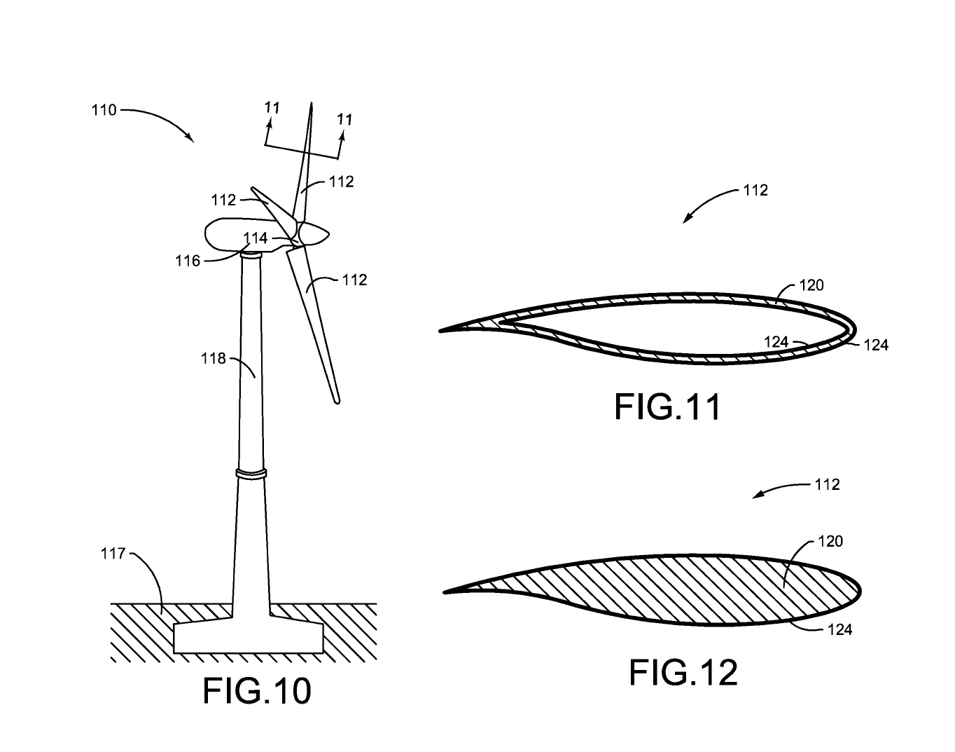

Referring now to FIGS. 10 and 11, a wind turbine 110 having plated polymeric blades 112 is shown. The wind turbine 110 may be involved in converting wind energy into electrical energy. The plated polymeric blades 112 may be connected to a hub 114 and the hub 114 may be attached to a nacelle 116 which houses mechanical and electrical components required for converting wind energy into electrical energy. The blades 112, the hub 114, and the nacelle 116 may be supported at a given height above a support surface 117 sufficient to provide clearance for the rotating blades 112 by a pole 118, as shown. The wind turbine 110 may include several other features which will be apparent to those skilled in the art. Importantly, the plated polymeric blades 112 may be lightweight and high in structural strength by virtue of their plated polymeric material construction (see further details below). The lightweight and high-strength construction of the plated polymeric blades 112 may lead to advantageous reductions in manufacturing costs and installation costs, as well as improvements in aerodynamic functions and impact resistance.

The plated polymeric construction of the blades 112 is shown in the cross-sectional view of FIG. 11. In particular, the plated polymeric blades 112 may consist of a polymeric substrate 120 plated on one or more of its surfaces with one or more metallic plating layers 124, as shown. The polymeric substrate 120 may be formed in the shape of the desired wind turbine blade and may have a tear-drop shape in cross-section. As one possibility, the polymeric substrate 120 may be plated with one or more metallic plating layers 124 on both its interior surface and its exterior surface, as shown in FIG. 11. As additional possibilities, the polymeric substrate 120 may have one or more metallic plating layers 124 only on its exterior surface or only on its interior surface, depending on the design requirements of the wind turbine blade. As another alternative possibility, the polymeric substrate 120 may fill the internal space of the blade 112 and the polymeric substrate 120 may be plated on one or more of its exterior surfaces with one or more metallic plating layers 124, as shown in FIG. 12. In addition, in any of the above-described arrangements, the metallic plating layer 124 may be deposited on select regions of the interior or exterior surfaces of the polymeric substrate 120.

The polymeric substrate 120 may be formed from a thermoplastic material or a thermoset material, either of which may be optionally reinforced with one or more types of reinforcing materials such as, but not limited to, carbon or glass. Suitable thermoplastic materials may include, but are not limited to, polyetherimide (PEI), thermoplastic polyimide, polyether ether ketone (PEEK), polyether ketone ketone (PEKK), polysulfone, polyamide, polyphenylene sulfide, polyester, polyimide, and combinations thereof. Suitable thermoset materials may include, but are not limited to, condensation polyimides, addition polyimides, epoxy cured with aliphatic and/or aromatic amines and/or anhydrides, cyanate esters, phenolics, polyesters, polybenzoxazine, polyurethanes, polyacrylates, polymethacrylates, silicones (thermoset), and combinations thereof. The thickness of the polymeric substrate 120 may vary depending on the molding process used to form the polymeric substrate. For example, the thickness of the polymeric substrate 120 may range from about 0.05 inches (about 1.27 mm) to about 0.25 inches (about 6.35 mm) if it is formed by injection molding, whereas its thickness may range from about 0.05 inches (about 1.27 mm) to about two inches (about 51 mm) if it is formed by compression molding.

The metallic plating layer(s) 124 may consist of one or more metals such as, but not limited to, nickel, cobalt, copper, iron, gold, silver, palladium, rhodium, chromium, zinc, tin, cadmium, and alloys with any of the foregoing elements comprising at least 50 wt. % of the alloy, and combinations thereof. The metallic plating layer 124 may have an average thickness in the range of about 0.004 inches (about 0.102 mm) to about 0.150 inches (about 3.81 mm), with local thicknesses in the range of about 0.001 inches (about 0.025 mm) to about 0.250 inches (about 6.35 mm) but other metallic plating layer thicknesses may also apply depending on the design requirements. This range of metallic plating layer thicknesses may provide the blades 112 with resistance to erosion, impact, and/or foreign-object damage (e.g., bird strike). In addition, this range of metallic plating layer thicknesses may also provide the option to finish the metallic surfaces of the blades 112 more aggressively to meet tight tolerances and/or surface finish requirements.

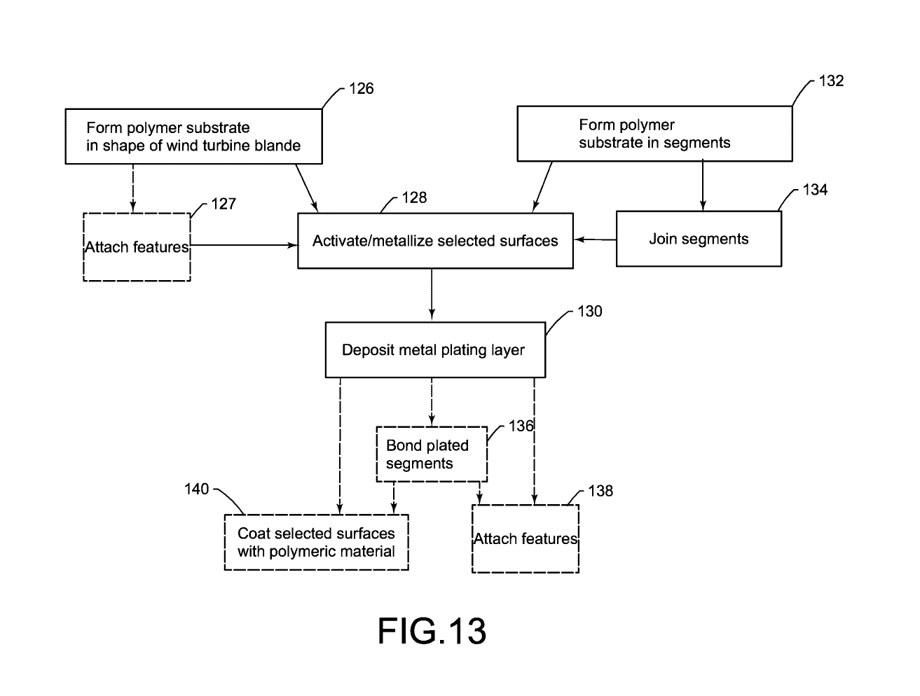

Various methods for fabricating the plated polymeric blade 112 are shown in FIG. 13. Beginning with a first block 126, the polymeric substrate 120 may be formed from selected thermoplastic materials or thermoset materials (with optional reinforcement) in a shape of the desired wind turbine blade. It may be formed in the desired shape using a range of polymer molding processes apparent to those skilled in the art such as, but not limited to, injection molding, compression molding, blow molding, additive manufacturing (liquid bed, powder bed, deposition), or composite layup (autoclave, compression, or liquid molding). To simplify the mold tooling, additional features (e.g., mounting features, flanges, bosses, etc.) may be attached to the polymeric substrate 120 after the block 126, according to an optional block 127. Such features may be attached by bonding using a suitable adhesive. Following the block 126 (or the optional block 127), interior or exterior surfaces of the polymeric substrate 120 which are selected for plating with the metallic plating layer 124 may be suitably activated and metallized according to a next block 128. Activation and metallization of the selected surfaces of the polymeric substrate 120 may be carried out using well-established methods in the industry and may result in metallic (conductive) surfaces being formed on the treated surfaces of the polymeric substrate 120, allowing the subsequent deposition of the metallic plating layer(s) 124 thereon.

Following the block 128, one or more metallic plating layers 124 may be deposited on the activated/metallized surfaces of the polymeric substrate 120 according to a next block 130. Deposition of the metallic plating layer(s) 124 may be carried out using metal deposition methods apparent to those skilled in the art such as, but not limited to, electroplating, electroless plating, or electroforming. If desired, masking of selected surfaces of the polymeric substrate 120 may be employed to yield different thicknesses of the metallic plating layer 124, or no plating on the selected areas, as will be understood by those skilled in the art. In addition, if desired, a customized metallic plating layer thickness profile on the surfaces of the polymeric substrate 120 may be achieved using tailored racking tools (e.g., shields, thieves, conformal anodes, etc.), as will be understood by those skilled in the art. Customization of the thickness profile of the metallic plating layer(s) 124 by masking and/or by the use of tailored racking tools may allow for optimization of desired properties (e.g., structural support, surface characteristics, fire resistance, etc.) of the wind turbine blades, without adding undue weight to the blades 112 to accommodate each of the desired properties.

As an alternative method to fabricate the plated polymeric blade 112, the polymeric substrate 120 may be formed in two or more segments according to a block 132, as shown. The segments of the polymeric substrate 120 may be formed in desired shapes from thermoplastic or thermoset materials (with optional reinforcement) using one or more of the polymer molding processes described above. Following the block 132, the polymer segments may be joined to form the full-scale polymeric substrate 120, according to a next block 134, as shown. Joining of the polymer segments may be achieved using conventional processes such as, but not limited to, welding (ultrasonic, laser, friction, friction-stir, traditional, etc.), adhesive bonding, or formation of mitered joints (with or without adhesive), as will be apparent to those skilled in the art. Upon completion of the block 134, selected surfaces of the polymeric substrate 120 may then be suitably activated and metallized (block 128) and one or more metallic plating layers 124 may be deposited on the activated/metallized surfaces (block 130), using the activation/metallization and metal deposition techniques described above.

As another alternative fabrication method, selected surfaces of each of the polymer segments formed by the block 132 may be activated and metallized (block 128) and one or more metallic plating layers 124 may be deposited on the activated/metallized surfaces of the polymer segments (block 130), using the methods described above. The plated segments may then be bonded together to form the full-scale plated polymeric blade 112 according to the block 136, as shown. Bonding of the plated segments may be achieved using transient liquid phase (TLP) bonding, as will be understood by those skilled in the art.

Once the plated polymeric blade 112 is formed by one of the above-described methods, it may be further processed according to the optional blocks 138 and/or 140, as shown. For example, additional features (e.g., bosses, inserts, etc.) may be attached to the blade 112 according to the optional block 138. Attachment of such additional features may be achieved using a suitable adhesive, a fastener (e.g., rivets, etc.), or another bonding process. In addition, selected surfaces of the blade 140 may be coated with one or more polymeric materials according to the optional block 140. Coating of the blade 112 with the polymeric material may be achieved using conventional processes such as, but not limited to, spray coating or dip coating. In addition, coating of the blade 112 with the polymeric material may provide a lightweight, stiff, and strong polymeric-appearing (non-conductive) product. Once the plated polymeric blade 112 is formed, it may be assembled with other necessary structures (i.e., other plated polymeric blades 112, the nacelle 116, the pole 118, etc.) to provide the wind turbine 110, as will be understood by those skilled in the art.

From the foregoing, it can therefore be seen that the present disclosure can find industrial applicability in many situations such as, but not limited to, situations that may benefit from lightweight and high-strength wind turbine blades. The plated polymeric wind turbine blades as disclosed herein may proved lightweight and high-strength alternatives for existing wind turbine blades and may lead to advantageous reductions in manufacturing costs and installation costs, as well as improvements in impact resistance. Furthermore, the thickness of the metallic plating layer in different areas of the blade may be tailored to provide desired properties such as resistance against impact (e.g., bird strike). Schedule savings may also be realized for the manufacture of the plated polymeric blades given the high-throughput molding and plating processes described herein. The technology as disclosed herein may find industrial applicability in the power generation industry.

Plated Polymeric Satellite Components

Space satellites are employed for numerous applications such as telecommunications, weather monitoring, navigation, research, and military applications. They are launched into orbit after release from a rocket at a suitable altitude above the earth. Although space satellites may have various configurations, most share common structures such as one or more antennae, one or more solar panels to provide power, and a frame that contains equipment necessary for the operation of the satellite (e.g., propulsion systems, fuel tanks, batteries, computers, etc.). However, satellite applications are extremely weight-sensitive because the payload (or carrying capacity) of the satellite is dependent upon the weight that the rocket motor is capable of lifting into space. Clearly, there is a need for lightweight constructions for satellite components to allow additional equipment to be incorporated into the satellite's payload.

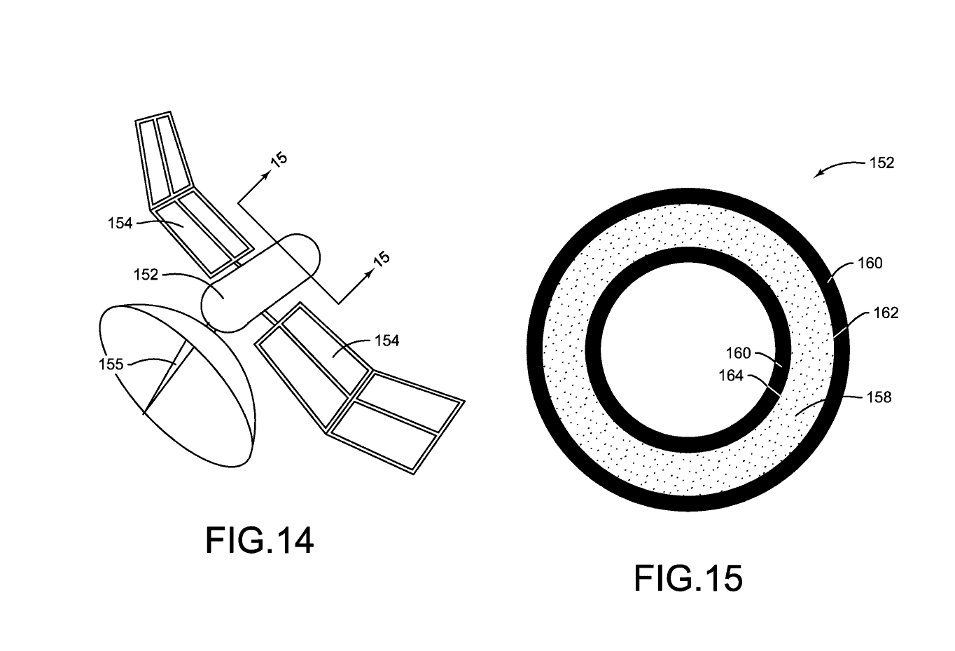

Referring now to FIGS. 14 and 15, a satellite 150 having a plated polymeric frame 152 is shown. The satellite 150 may be employed for various applications such as, but not limited to, space exploration, telecommunications, research, or military applications. In this regard, depending on its intended use, the satellite 150 may have a structure which deviates from the exemplary structure depicted in FIG. 14. In addition to the plated polymeric frame 152, the satellite 150 may also have one or more solar panels 154, for providing energy to the satellite 150, and one or more antennae 155, as shown. The plated polymeric frame 152 may carry components necessary for the operation of the satellite such as, but not limited to, fuel tanks, batteries, computers, and a propulsion system. Importantly, the plated polymeric frame 152 of the satellite 150 may be lightweight and high in structural strength by virtue of its plated polymeric construction (see further details below). The lightweight and high-strength construction of the plated polymeric frame 152 may lead to increases in the payload (i.e., carrying capacity) of the satellite 150 as well as other advantageous properties.

The plated polymeric construction of the frame 152 is best shown in the cross-sectional view of FIG. 15. In particular, FIG. 15 shows the walls of the frame 152 with internal items (e.g., fuel tanks, batteries, etc.) and the back wall of the frame 152 removed for clarity purposes. The plated polymeric frame 152 may consist of a polymeric substrate 158 plated on one or more of its surfaces with one or more metallic plating layers 160, as shown. The polymeric substrate 158 may be formed in the shape of the walls of the desired satellite frame, which may deviate from the cylindrical structure depicted in FIG. 14. As one possibility, the polymeric substrate 158 may have one or more metallic plating layers 160 applied to both its outer surface 162 and its inner surface 164, as shown. As additional possibilities, the polymeric substrate 158 may be plated only on its outer surface 162 or only on its inner surface 164, depending on the design requirements of the satellite frame. As another alternative possibility, one or more metallic plating layers 160 may be deposited only on selected regions of the either or both of the outer surface 162 and the inner surface 164.

The polymeric substrate 158 may be formed from a thermoplastic material or a thermoset material, either of which may be optionally reinforced with one or more types of reinforcing materials such as, but not limited to, carbon or glass. Suitable thermoplastic materials may include, but are not limited to, polyetherimide (PEI), thermoplastic polyimide, polyether ether ketone (PEEK), polyether ketone ketone (PEKK), polysulfone, polyamide, polyphenylene sulfide, polyester, polyimide, and combinations thereof. Suitable thermoset materials may include, but are not limited to, condensation polyimides, addition polyimides, epoxy cured with aliphatic and/or aromatic amines and/or anhydrides, cyanate esters, phenolics, polyesters, polybenzoxazine, polyurethanes, polyacrylates, polymethacrylates, silicones (thermoset), and combinations thereof.

The metallic plating layer(s) 160 may consist of one or more metals selected from nickel, cobalt, copper, iron, gold, silver, palladium, rhodium, chromium, zinc, tin, cadmium, and alloys with any of the foregoing elements comprising at least 50 wt. % of the alloy, and combinations thereof. The metallic plating layer 160 may have an average thickness in the range of about 0.0005 inches (about 0.0127 mm) to about 0.025 inches (about 0.635 mm), with localized thicknesses in the range of about 0.0001 inches (about 0.0025 mm) to about 0.050 inches (about 1.27 mm), but other thickness ranges may also be used. For example, thicker metallic plating layers may exist where more structural support is required on the body of the frame 152.

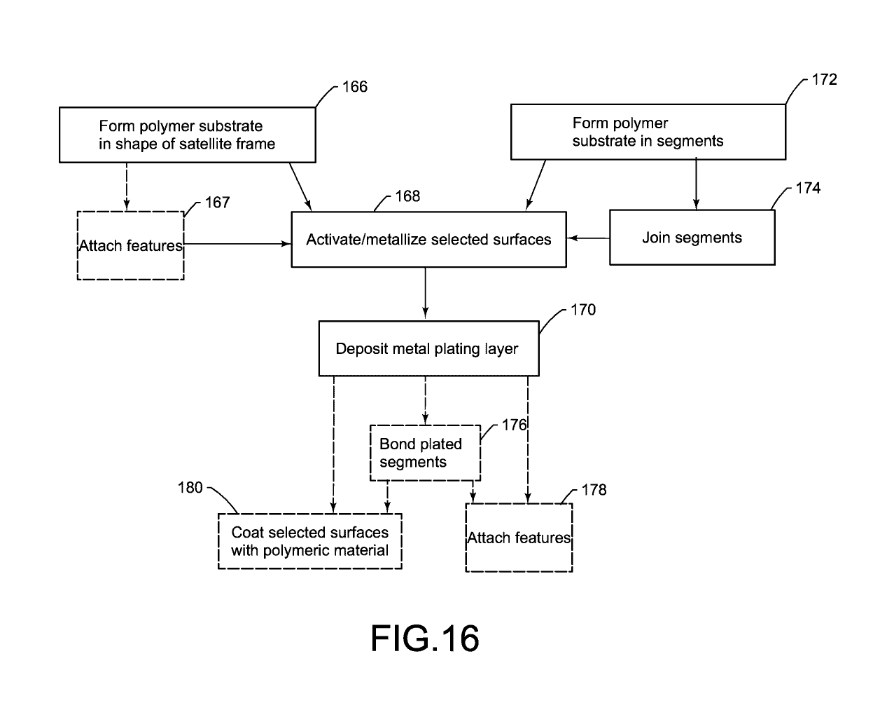

Various methods for fabricating the plated polymeric frame 152 are shown in FIG. 16. Beginning with a first block 166, the polymeric substrate 158 may be formed from selected thermoplastic materials or thermoset materials (with optional reinforcement) in a shape of the walls of the desired satellite frame. It may be formed in the desired shape using a range of polymer molding processes apparent to those skilled in the art such as, but not limited to, injection molding, compression molding, blow molding, additive manufacturing (liquid bed, powder bed, deposition), or composite layup (autoclave, compression, or liquid molding). To simplify the mold tooling, additional features (e.g., mounting features, flanges, bosses, etc.) may be attached to the polymeric substrate 158 after the block 166, according to an optional block 167. Such features may be attached by bonding using a suitable adhesive. Following the block 166 (or the optional block 167), outer and/or inner surfaces of the polymeric substrate 158 which are selected for plating with the metallic plating layer 160 may be suitably activated and metallized according to a next block 168. Activation and metallization of the selected surfaces of the polymeric substrate 158 may be carried out using well-established methods in the industry and may result in metallic (conductive) surfaces being formed on the treated surfaces of the polymeric substrate 158, allowing the subsequent deposition of the metallic plating layer(s) 160 thereon.

Following the block 168, one or more metallic plating layers 160 may be deposited on the activated/metallized surfaces of the polymeric substrate 158 according to a next block 170. Deposition of the metallic plating layer(s) 160 may be carried out using metal deposition methods apparent to those skilled in the art such as, but not limited to, electroplating, electroless plating, or electroforming. If desired, masking of selected surfaces of the polymeric substrate 158 may be employed to yield different thicknesses of the metallic plating layer 160, or no plating on the selected areas, as will be understood by those skilled in the art. In addition, if desired, a customized metallic plating layer thickness profile on the surfaces of the polymeric substrate 158 may be achieved using tailored racking tools (e.g., shields, thieves, conformal anodes, etc.), as will be understood by those skilled in the art. Customization of the thickness profile of the metallic plating layer(s) 160 by masking and/or by the use of tailored racking tools may allow for optimization of desired properties (e.g., structural support, surface characteristics, etc.) of the frame 152, without adding undue weight to the frame 152 to accommodate each of the desired properties.

As an alternative method to fabricate the plated polymeric frame 152, the polymeric substrate 158 may be formed in two or more segments according to a block 172, as shown. The segments of the polymeric substrate 158 may be formed in desired shapes from thermoplastic or thermoset materials (with optional reinforcement) using one or more of the polymer molding processes described above. Following the block 172, the polymer segments may be joined to form the full-scale polymeric substrate 158, according to a next block 174, as shown. Joining of the polymer segments may be achieved using conventional processes such as welding (ultrasonic, laser, friction, friction-stir, traditional, etc.), adhesive bonding, or formation of mitered joints (with or without adhesive), as will be apparent to those skilled in the art. Upon completion of the block 174, selected surfaces of the polymeric substrate 158 may then be suitably activated and metallized (block 168) and one or more metallic plating layers 160 may be deposited on the activated/metallized surfaces (block 170), according to the activation/metallization and metal deposition processes above.

As another alternative fabrication method, selected surfaces of each of the polymer segments formed by the block 172 may be activated and metallized (block 168) and one or more metallic plating layers 160 may be deposited on the activated/metallized surfaces of the polymer segments (block 170), using the activation/metallization methods and metal deposition methods described above. The plated segments may then be bonded together to form the full-scale plated polymeric frame 152 according to the block 176, as shown. Bonding of the plated segments may be achieved using transient liquid phase (TLP) bonding, as will be understood by those skilled in the art.

Once the plated polymeric frame 152 is formed by one of the above-described methods, it may be further processed according to optional blocks 178 and/or 180, as shown. For example, additional features (e.g., bosses, inserts, etc.) may be attached to the frame 152 according to the optional block 178. Attachment of such additional features may be achieved using a suitable adhesive, a fastener (e.g., rivets, bolts, etc.), or another bonding process. In addition, selected surfaces of the frame 152 may be coated with one or more polymeric materials according to the optional block 180. Coating of the plated polymeric frame 152 with the polymeric material may be achieved using conventional processes such as, but not limited to, spray coating or dip coating. In addition, coating of the frame 152 with the polymeric material may provide a lightweight, stiff, and strong polymeric-appearing (non-conductive) product.

As can be appreciated, the plated polymeric construction as disclosed herein for the satellite frame 152 may also be employed for other satellite components to provide lightweight and high-strength satellite structures.

From the foregoing, it can therefore be seen that the present disclosure can find industrial applicability in many situations such as, but not limited to, situations which may benefit from lightweight satellite component constructions. The plated polymeric satellite component construction as disclosed herein may provide lightweight alternatives for existing material constructions for satellite components. In particular, the lightweight plated polymeric satellite frame may allow for additional components (e.g., equipment, sensors, fuel, etc.) to be incorporated into the satellite's payload. In addition, reducing the weight of satellite components may result in reductions in input required to re-position the satellite once it is in its position and may also lengthen the life of the satellite once it is in its position. Furthermore, complex geometries for satellite components may be accessed by the polymer molding techniques described herein and/or by producing multiple polymeric segments and joining them together before plating. Schedule savings may also be realized given the high-throughput polymer molding and plating processes described herein. The technology as disclosed herein may find industrial applicability in a wide range of areas such as space exploration, telecommunication, and military industries.

Plated Polymeric Leaf Spring

Leaf springs are used for suspension in wheeled vehicles and are arc-shaped or elliptically-shaped structures formed from steel or other materials. They are formed from one or more “leaves” which may be stacked upon each other as needed to provide the vehicle with a desired level of suspension. For example, more leaves may be required for heavier vehicles. The center of the arc may be connected to the axle of the vehicle by a U-bolt or another type of mechanical fastening arrangement, and the leaf spring may have ends for attaching to the body of the vehicle. In general, it is desirable that leaf springs possess a certain level of stiffness and strength for safety and fatigue resistance. It is also desirable that leaf springs are lightweight to for fuel efficiency reasons. In general, there is a need for lightweight and high-strength material constructions for leaf springs.

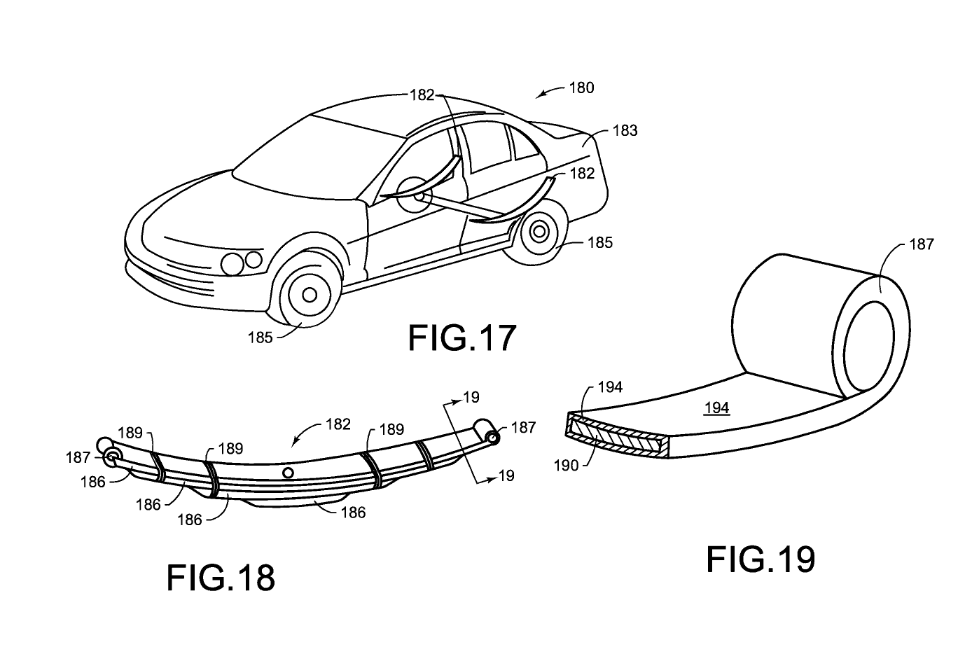

Referring now to FIG. 17, a wheeled vehicle 180 having plated polymeric leaf springs 182 is shown. The wheeled vehicle 180 may have a body 183, an axle 184, and wheels 185 connected to the axle 184, as shown. The plated polymeric leaf springs 182 may assist in suspending the body 183 of the vehicle on the wheels 185. Each of the plated polymeric leaf springs 182 may be arc-shaped and may consist of a variable number of arc-shaped leaves 186 which may be stacked upon each other to provide a desired level of suspension, as best shown in FIG. 18. In addition, the leaf springs 182 may connect to the axle 184 at or near the center of the arc structure with a fastener such as a U-bolt or other fastening or bonding arrangement. The leaf springs 182 may also have ends 187 for connecting to the body of the vehicle and one or more clips 189 (or another type of fastening or bonding arrangement) for securing the leaves 186 together. Importantly, by virtue of their plated polymeric construction (see further details below), the leaf springs 182 may be lightweight and high in structural strength.

The plated polymeric construction of the leaf springs 182 is best shown in FIG. 19. In particular, a cross-sectional view of one of the leaves 186 of the leaf spring 182 is shown in FIG. 19. Each leaf 186 of the plated polymeric leaf spring 182 may consist of a polymeric substrate 190 plated on one or more of its outer surfaces with one or more metallic plating layers 194. The polymeric substrate 190 may be formed in the shape of the leaf 186 with ends 187 if necessary. As one possibility, the polymeric substrate 190 may be plated with one or more metallic plating layers 194 on all of its outer surfaces, as shown in FIG. 19. As another possibility, the polymeric substrate 190 may be plated with one or more metallic plating layers 194 on selected regions of its outer surface. A desired number of the plated polymeric leaves 186 may be assembled to form the leaf spring 182, as shown in FIG. 18.

The polymeric substrate 190 may be formed from a thermoplastic material or a thermoset material, either of which may be optionally reinforced with one or more types of reinforcing materials such as, but not limited to, carbon or glass. Suitable thermoplastic materials may include, but are not limited to, polyetherimide (PEI), thermoplastic polyimide, polyether ether ketone (PEEK), polyether ketone ketone (PEKK), polysulfone, polyamide, polyphenylene sulfide, polyester, polyimide, and combinations thereof. Suitable thermoset materials may include, but are not limited to, condensation polyimides, addition polyimides, epoxy cured with aliphatic and/or aromatic amines and/or anhydrides, cyanate esters, phenolics, polyesters, polybenzoxazine, polyurethanes, polyacrylates, polymethacrylates, silicones (thermoset), and combinations thereof. The thickness of the polymeric substrate 190 may vary depending on the molding process used to form the polymeric substrate. For example, the thickness of the polymeric substrate 190 may range from about 0.050 inches (about 1.27 mm) to about 0.25 inches (about 6.35 mm) if it is formed by injection molding, whereas its thickness may range from about 0.050 inches (about 1.27 mm) to about two inches (about 51 mm) if it is formed by compression molding.

The metallic plating layer(s) 194 may consist of one or more metals selected from nickel, cobalt, copper, iron, gold, silver, palladium, rhodium, chromium, zinc, tin, cadmium, and alloys with any of the foregoing elements comprising at least 50 wt. % of the alloy, and combinations thereof. The metallic plating layer 194 may have an average thickness in the range of about 0.004 inches (about 0.10 mm) to about 0.100 inches (about 2.5 mm), with local thicknesses in the range of about 0.001 inches (about 0.025 mm) to about 0.200 inches (about 5.1 mm). This range of metallic plating layer thicknesses may provide the leaves 186 with resistance to erosion, impact, and/or fatigue. In addition, this range of thicknesses may also provide the option to finish the surfaces of the leaves 186 more aggressively to meet tight tolerances or surface finish requirements.

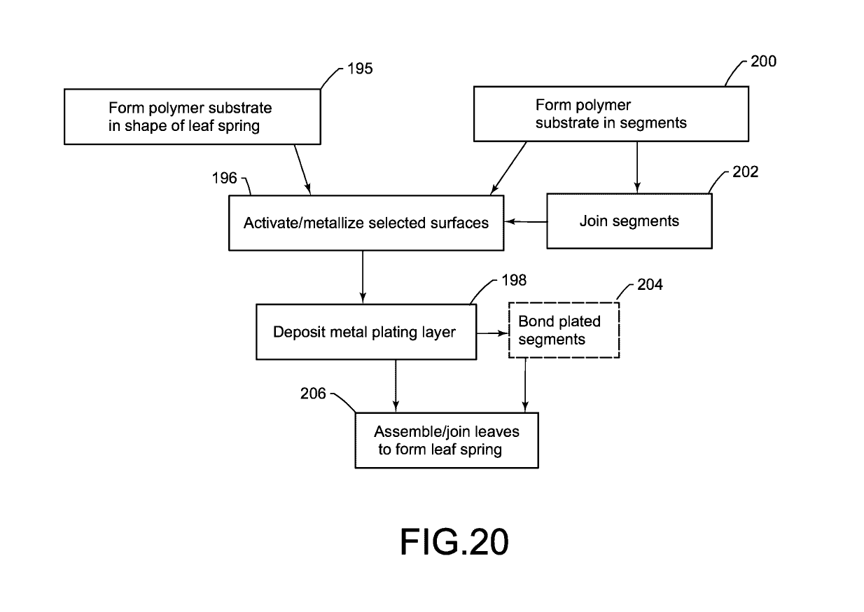

Different methods for fabricating the plated polymeric leaf spring 182 are shown in FIG. 20. Beginning with a first block 195, the polymeric substrate 190 may be formed from selected thermoplastic or thermoset materials (with optional reinforcement) in a shape of the desired leaf 186 (with or without the ends 187). It may be formed in the desired shape using a range of polymer molding processes apparent to those skilled in the art such as, but not limited to, injection molding, compression molding, blow molding, additive manufacturing (liquid bed, powder bed, deposition), or composite layup (autoclave, compression, or liquid molding). Following the block 195, outer surfaces of the polymeric substrate 190 which are selected for plating with the metallic plating layer 194 may be suitably activated and metallized according to a next block 196. Activation and metallization of the selected outer surfaces of the polymeric substrate 190 may be carried out using well-established methods in the industry and may result in metallic (conductive) surfaces being formed on the treated surfaces of the polymeric substrate 190, allowing the subsequent deposition of the metallic plating layer(s) 194 thereon.

Following the block 196, one or more metallic plating layers 194 may be deposited on the activated/metallized surfaces of the polymeric substrate 190 according to a next block 198. Deposition of the metallic plating layer(s) 194 may be carried out using one or more metal deposition methods apparent to those skilled in the art such as, but not limited to, electroplating, electroless plating, or electroforming. If desired, masking of selected outer surfaces of the polymeric substrate 190 may be employed to yield different thicknesses of the metallic plating layer or no plating on the selected areas, as will be understood by those skilled in the art. In addition, if desired, a customized metallic plating layer thickness profile on the surfaces of the polymeric substrate 190 may be achieved using tailored racking tools (e.g., shields, thieves, conformal anodes, etc.), as will be understood by those skilled in the art. Customization of the thickness profile of the metallic plating layer(s) 190 by masking and/or by the use of tailored racking tools may allow for optimization of desired properties (e.g., fire resistance, structural support, surface characteristics, etc.) of the leaf 186, without adding undue weight to the leaf 186 or the leaf spring 182 to accommodate each of the desired surface properties. Completion of the block 198 may provide the plated polymeric leaf 186. The blocks 194, 196, and 198 may be repeated as necessary to provide the desired number of leaves 186 for the leaf spring 182.

As an alternative method to fabricate the plated polymeric leaves 186, the polymeric substrate 190 may be formed in two or more segments according to a block 200, as shown. The segments of the polymeric substrate 190 may be formed in desired shapes from the thermoplastic or thermoset materials (with optional reinforcement) described above using one or more of the polymer molding processes described above. Following the block 200, the polymer segments may be joined to form the full-scale polymeric substrate 190, according to a next block 202, as shown. Joining of the polymer segments may be achieved using conventional processes such as welding (ultrasonic, laser, friction, friction-stir, traditional, etc.), adhesive bonding, or formation of mitered joints (with or without adhesive), as will be apparent to those skilled in the art. Upon completion of the block 202, selected surfaces of the polymeric substrate 190 may be suitably activated and metallized (block 196) and one or more metallic plating layers 194 may be deposited on the activated/metallized surfaces (block 198), using the activation/metallization and metal deposition methods described above with the optional use of masking and/or tailored racking tools.

As another alternative fabrication method, selected surfaces of each of the polymer segments formed by the block 200 may be activated and metallized (block 196) and one or more metallic plating layers 194 may be deposited on the activated/metallized surfaces of each of the polymer segments (block 198), using the methods described above (with the optional use of masking and/or tailored racking methods), to provide plated polymeric segments of the leaf 186. The plated segments may then be bonded together to form the full-scale leaf 186 according to the block 204, as shown. Bonding of the plated segments may be achieved using transient liquid phase (TLP) bonding, as will be understood by those skilled in the art.

Once the desired number of plated polymeric leaves 186 are formed by one of the above-described methods, they may be assembled (or stacked) and joined together according to a block 206 to provide the plated polymeric leaf spring 182. Joining of the plated polymeric leaves 186 may be achieved using a mechanical fastener (as shown in FIG. 18) or by bonding the leaves 186 together by transient liquid phase bonding, as will be apparent to those skilled in the art.

From the foregoing, it can therefore be seen that the present disclosure can find industrial applicability in many situations such as, but not limited to, situations which may benefit from lightweight and high-strength leaf spring constructions. The plated polymeric leaf spring construction as disclosed herein may provide lightweight alternatives for existing material constructions for leaf springs, while maintaining a necessary level of stiffness and strength. In addition, the thickness of the metallic plating layers on the leaves may be tailored to provide improved levels of structural support and fatigue resistance. The lightweight plated polymeric leaf spring may address a vehicle's fuel economy requirements, and may be particularly advantageous for electric vehicles where weight is a strong limiting factor. The technology as disclosed herein may find industrial applicability in a wide range of areas such as, but not limited to, automotive industries and military transport industries.

Plated Polymeric Pulley

Pulleys are widely used for lifting loads or applying forces in a wide range of applications. A pulley consists of a wheel on an axle and is used to support movement of one or more cables (e.g., ropes, chains, belts, etc.) to lift loads, apply forces, etc. Pulleys may have one or more grooves located between flanges for guiding the movement of the cable. They are required to be relatively lightweight, stiff, and fatigue resistant and should also possess a reasonably high structural strength to resist loads during use. In addition, to be commercially competitive, pulleys must be fabricated rapidly and at low cost. Clearly, there is a need for lightweight and high strength pulley constructions that may be fabricated quickly and at relatively low costs.

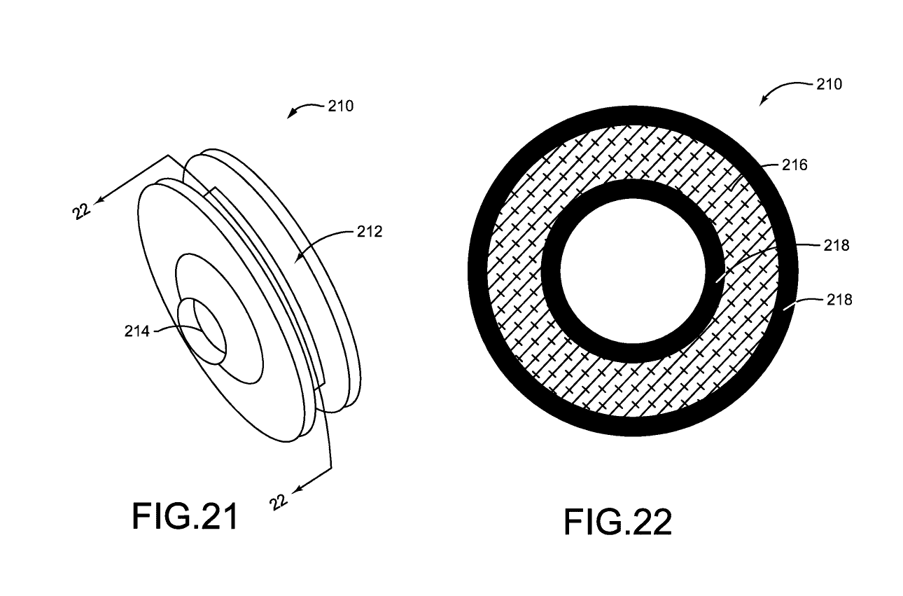

Referring now to FIG. 21, a plated polymeric pulley 210 is shown. The plated polymeric pulley 210 may have one or more grooves 212 for guiding one or more cables (e.g., ropes, cables, chains, belts, etc.) and an aperture 214 for receiving an axle. It may be used for various applications such as lifting loads, applying forces, or transmitting power. In addition, depending on its application, the plated polymeric pulley 210 may have a structure which deviates substantially from the exemplary structure depicted in FIG. 21. By virtue of its plated polymeric construction (see further details below), the pulley 210 may be lightweight and high in strength such that it may be fatigue-resistant and able to resist loads.

The plated polymeric construction of the pulley 210 is best shown in FIG. 22. In particular, it may consist of a polymeric substrate 216 plated on one or more it its exposed surfaces with one or more metallic plating layers 218, as shown. The polymeric substrate 216 may be formed in the shape of the desired pulley (i.e., with the desired diameter, thickness, number of grooves, etc.). As one possibility, the polymeric substrate 216 may be plated with one or more metallic plating layers 218 on all of its exposed surfaces, as shown in FIG. 22. Alternatively, it may be plated on selected exposed surfaces to impart selected regions of the pulley 210 with increased strength. In addition, the plated polymeric pulley 210 may have a shape in which certain regions not directly contributing to its load-carrying capability are removed in order to provide an even lighter weight part (e.g., a spoked design). In any event, the plated polymeric pulley 210 may have the advantageous properties of both polymeric materials (i.e., lightweight, readily moldable into a variety of shapes, etc.) and metallic materials (i.e., high strength, fatigue resistance, etc.).

The polymeric substrate 216 may be formed from a thermoplastic material or a thermoset material, either of which may be optionally reinforced with one or more types of reinforcing materials such as, but not limited to, carbon or glass. Suitable thermoplastic materials may include, but are not limited to, polyetherimide (PEI), thermoplastic polyimide, polyether ether ketone (PEEK), polyether ketone ketone (PEKK), polysulfone, nylon, polyamide, polyphenylene sulfide, polyester, polyimide, and combinations thereof. Suitable thermoset materials may include, but are not limited to, condensation polyimides, addition polyimides, epoxy cured with aliphatic and/or aromatic amines and/or anhydrides, cyanate esters, phenolics, polyesters, polybenzoxazine, polyurethanes, polyacrylates, polymethacrylates, silicones (thermoset), and combinations thereof. The thickness of the polymeric substrate 216 may vary depending on the molding process used to form the polymeric substrate. For example, the thickness of the polymeric substrate 216 may range from about 0.050 inches (about 1.27 mm) to about 0.25 inches (about 6.35 mm) if it is formed by injection molding, whereas its thickness may range from about 0.050 inches (about 1.27 mm) to about two inches (about 51 mm) if it is formed by compression molding.

The metallic plating layer(s) 218 may consist of one or more metals selected from nickel, cobalt, copper, iron, gold, silver, palladium, rhodium, chromium, zinc, tin, cadmium, and alloys with any of the foregoing elements comprising at least 50 wt. % of the alloy, and combinations thereof. The metal plating layer 218 may have an average thickness in the range of about 0.001 inches (about 0.025 mm) to about 0.050 inches (about 1.27 mm), with localized thicknesses in the range of about 0.0001 inches (about 0.00254 mm) to about 0.100 inches (about 2.54 mm). This range of metallic plating layer thicknesses may provide the pulley 210 with resistance to erosion, impact, and/or fatigue. In addition, this range of thicknesses may also provide the option to finish the surfaces of the pulley 210 more aggressively to meet tight tolerances and/or surface finish requirements.

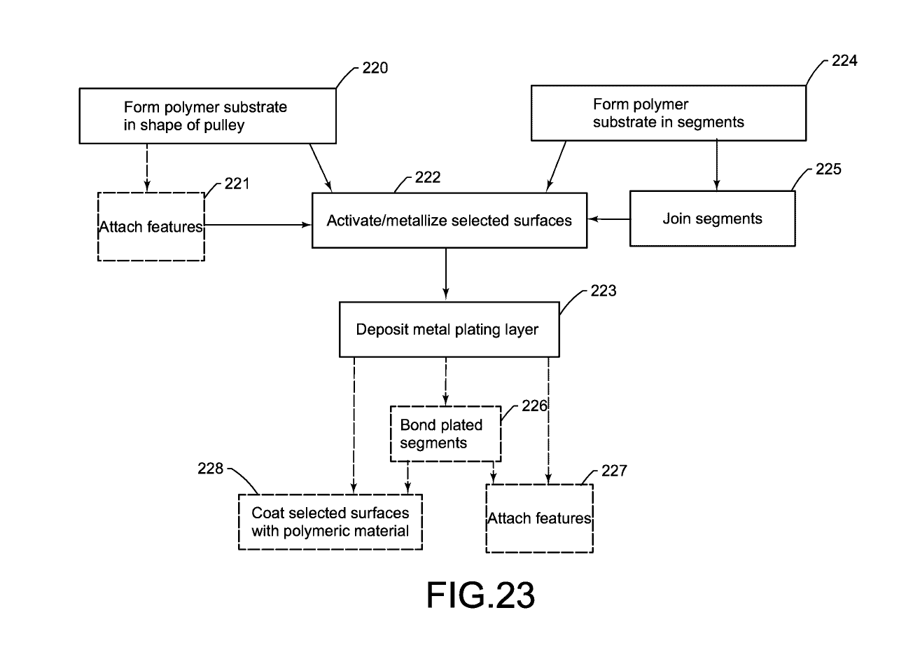

Different methods for fabricating the plated polymeric pulley 210 are shown in FIG. 23. Beginning with a first block 220, the polymeric substrate 216 may be formed from selected thermoplastic materials or thermoset materials (with optional reinforcement) in a shape of the desired pulley. It may be formed in the desired shape using a range of polymer molding processes apparent to those skilled in the art such as, but not limited to, injection molding, compression molding, blow molding, additive manufacturing (liquid bed, powder bed, deposition), or composite layup (autoclave, compression, or liquid molding). To simplify the mold tooling, additional features such as mounting features (e.g., flanges or bosses, spindle holes) may be attached to the polymeric substrate after the block 220, according to an optional block 221. Such features may be attached by bonding using a suitable adhesive. Following the block 220 (or the optional block 221), interior or exterior surfaces of the polymeric substrate 216 which are selected for plating with the metallic plating layer 218 may be suitably activated and metallized according to a next block 222. Activation and metallization of the selected surfaces of the polymeric substrate 216 may be carried out using well-established methods in the industry and may result in metallic (conductive) surfaces being formed on the treated surfaces of the polymeric substrate 216, allowing the subsequent deposition of the metallic plating layer 218 thereon.

Following the block 222, one or more metallic plating layers 218 may be deposited on the activated/metallized surfaces of the polymeric substrate 216 according to a next block 223. Deposition of the metallic plating layer(s) 218 may be carried out using metal deposition methods apparent to those skilled in the art such as, but not limited to, electroplating, electroless plating, or electroforming. If desired, masking of selected surfaces of the polymeric substrate 216 may be employed to yield different thicknesses of the metallic plating layer or no plating on the selected areas, as will be understood by those skilled in the art. In addition, if desired, a customized metallic plating layer thickness profile on the surfaces of the polymeric substrate 216 may be achieved using tailored racking tools (e.g., shields, thieves, conformal anodes, etc.), as will be understood by those skilled in the art. Customization of the thickness profile of the metallic plating layer(s) 218 by masking and/or by the use of tailored racking tools may allow for optimization of desired properties (e.g., fire resistance, structural support, surface characteristics, etc.) of the pulley 210, without adding undue weight to the pulley to accommodate each of these properties.

As an alternative method to fabricate the pulley 210, the polymeric substrate 216 may be formed in two or more segments according to a block 224, as shown. The segments of the polymeric substrate 216 may be formed in desired shapes from the thermoplastic or thermoset materials (with optional reinforcement) using one or more of the polymer molding processes described above. Following the block 224, the polymer segments may be joined to form the full-scale polymeric substrate 216, according to a next block 225, as shown. Joining of the polymer segments may be achieved using conventional processes such as, but not limited to, welding (ultrasonic, laser, friction, friction-stir, traditional, etc.), adhesive bonding, or formation of mitered joints (with or without adhesive), as will be apparent to those skilled in the art. Upon completion of the block 225, selected surfaces of the polymeric substrate 216 may be suitably activated and metallized (block 222) and one or more metallic plating layers 218 may be deposited on the activated/metallized surfaces (block 223), as described above.

As another alternative fabrication method, selected surfaces of each of the polymer segments formed by the block 224 may be activated and metallized (block 222) and one or more metallic plating layers 218 may be deposited on the activated/metallized surfaces of each of the polymer segments (block 223). The plated segments may then be bonded together to form the full-scale pulley 210 according to the block 226, as shown. Bonding of the plated segments may be achieved using transient liquid phase (TLP) bonding, as will be understood by those skilled in the art.

Once the plated polymeric pulley 210 is formed by one of the above-described methods, if desired, it may be further processed according to the optional blocks 227 and/or 228, as shown. For example, additional features (e.g., bosses, inserts, etc.) may be attached to the pulley 210 according to the optional block 227. Attachment of such additional features may be achieved using a suitable adhesive, a fastener (e.g., rivets, bolts, etc.), or another bonding process. A possible additional feature may include, but is not limited to, spindle holes to provide suitable offsets between the channels (when assembling multiple pulleys) or positioning when locating on an axle. In addition, selected surfaces of the pulley 210 may be coated with one or more polymeric materials according to the optional block 228. Coating of the pulley 210 may be achieved using conventional processes such as, but not limited to, spray coating or dip coating. Coating of the pulley 210 with the polymeric material may provide a lightweight, stiff, and strong polymeric-appearing (non-conductive) product.

From the foregoing, it can therefore be seen that the present disclosure can find industrial applicability in many situations such as, but not limited to, situations which may benefit from lightweight and high-strength pulley constructions. The plated polymeric pulley as disclosed herein may provide lightweight alternatives for existing pulley material constructions. In addition, the plated polymeric pulley may be high in strength and fatigue-resistant and it may be manufactured quickly at low cost compared with traditional pulley materials. The technology as disclosed herein may find applicability in a wide range of areas such as construction and mechanical applications.

Plated Polymeric Impeller

Impellers are widely used rotor components for increasing or decreasing pressure or flow of a fluid. They are typically located inside of a tube or a conduit and are used, for example, in pumps and hydroelectric (or hydropower) applications. To optimize their operation, impellers should be lightweight, erosion- and corrosion-resistant, and high in strength to resist impact and fatigue. However, in order to ensure that these properties are met in impeller constructions, current manufacturing methods may employ expensive and time consuming processes. Clearly, there is a need for improved material constructions and manufacturing methods for providing lightweight and high-strength impellers.

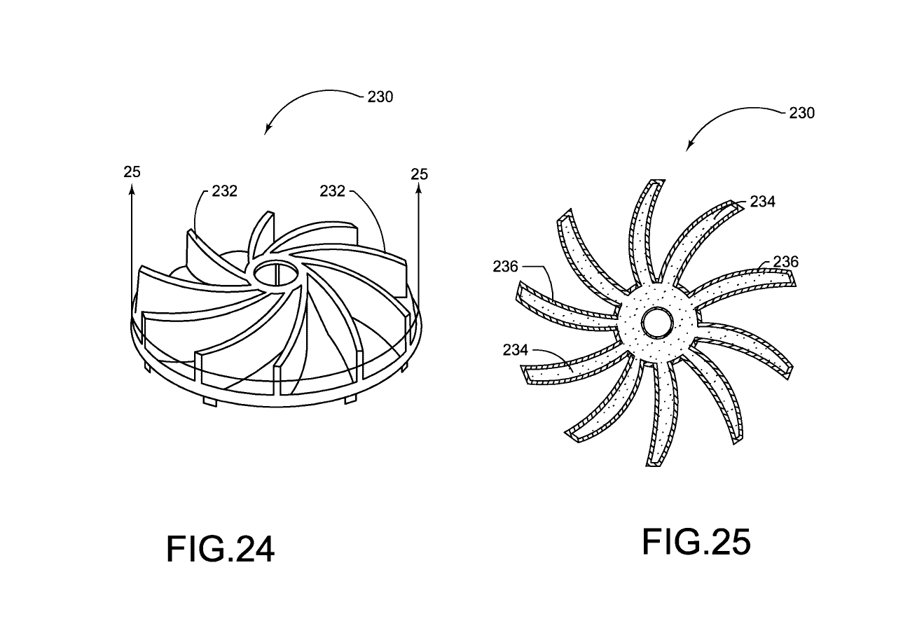

Referring now to FIG. 24, a plated polymeric impeller 230 is shown. The plated polymeric impeller 230 may have blades 232 which may rotate and influence the pressure and flow of a fluid. It may be used in a range of applications such as, but not limited to, pumping applications and hydroelectric applications. Depending on the application, the structure of the impeller 230 may deviate from the exemplary structure shown in FIG. 24. For example, it may have a different number of blades or blades with different geometries. Importantly, by virtue of its plated polymeric construction (see further details below), the impeller 230 may be high in strength, light in weight, and it may have a high fatigue resistance. It may be lighter in weight than impellers formed from traditional materials and processes such that it may offer a higher rate of power generation due to reduced turning resistance. Furthermore, it may be fabricated by methods which may offer cost and time savings over current processes used to manufacture impellers (see further details below).

The plated polymeric construction of the impeller 230 is best shown in FIG. 25. In particular, the plated polymeric impeller 230 may consist of a polymeric substrate 234 formed in the shape of the impeller and having one or more metallic plating layers 236 applied to its outer surfaces, as shown. As one possibility, the polymeric substrate 234 may have one or more metallic plating layers 236 applied to all of its outer surfaces, as shown in FIG. 25. Alternatively, it may have one or more metallic plating layers 236 applied to selected outer surfaces to impart selected regions of the impeller 230 with increased strength. In any event, the impeller 230 may have the advantageous properties of both polymeric components (i.e., lightweight, readily moldable into a variety of shapes, etc.) and metallic components (i.e., high strength, impact resistance, fatigue resistance, etc.).

The polymeric substrate 234 may be formed from a thermoplastic material or a thermoset material, either of which may be optionally reinforced with one or more types of reinforcing materials such as, but not limited to, carbon or glass. Suitable thermoplastic materials may include, but are not limited to, polyetherimide (PEI), thermoplastic polyimide, polyether ether ketone (PEEK), polyether ketone ketone (PEKK), polysulfone, nylon, polyamide, polyphenylene sulfide, polyester, polyimide, and combinations thereof. Suitable thermoset materials may include, but are not limited to, condensation polyimides, addition polyimides, epoxy cured with aliphatic and/or aromatic amines and/or anhydrides, cyanate esters, phenolics, polyesters, polybenzoxazine, polyurethanes, polyacrylates, polymethacrylates, silicones (thermoset), and combinations thereof. The thickness of the polymeric substrate 234 may vary depending on the molding process used to form the polymeric substrate. For example, the thickness of the polymeric substrate 234 may range from about 0.050 inches (about 1.27 mm) to about 0.25 inches (about 6.35 mm) if it is formed by injection molding, whereas its thickness may range from about 0.050 inches (about 1.27 mm) to about two inches (about 51 mm) if it is formed by compression molding.

The metallic plating layer(s) 236 may consist of one or more metals selected from nickel, cobalt, copper, iron, gold, silver, palladium, rhodium, chromium, zinc, tin, cadmium, and alloys with any of the foregoing elements comprising at least 50 wt. % of the alloy, and combinations thereof. The metallic plating layer 236 may have an average thickness in the range of about 0.020 inches (about 0.508 mm) to about 0.100 inches (about 2.54 mm), with localized thicknesses in the range of about 0.001 inches (about 0.025 mm) to about 0.200 inches (about 5.08 mm). This range of metallic plating layer thicknesses may provide desired properties such as impact resistance, corrosion resistance, erosion resistance, and foreign-object damage resistance. Furthermore, this range of metallic plating layer thicknesses may also provide the option to finish the surfaces of the impeller 230 more aggressively to meet tight tolerances and/or surface finish requirements.

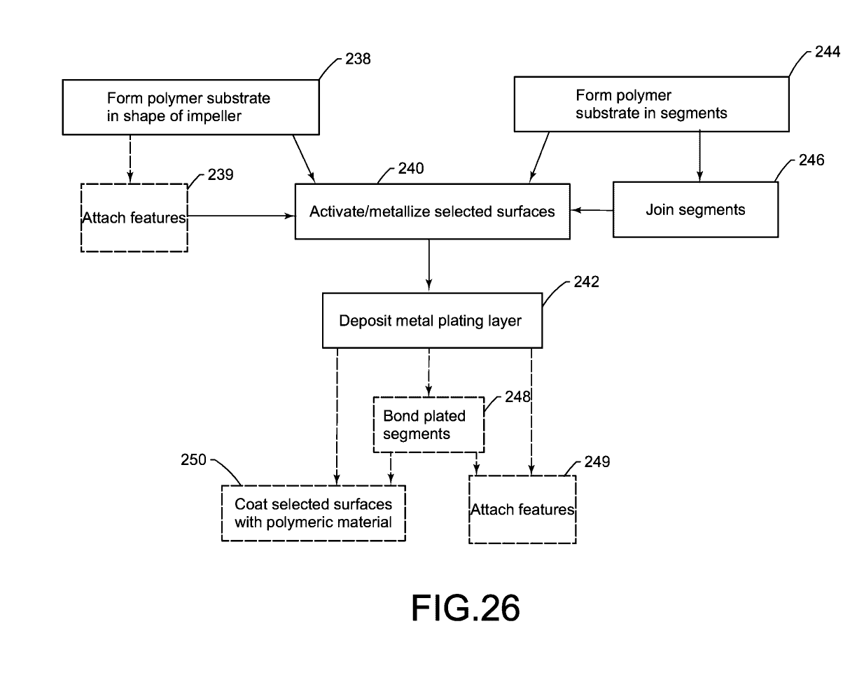

Various methods for fabricating the plated polymeric impeller 230 are shown in FIG. 26. Beginning with a first block 238, the polymeric substrate 234 may be formed from selected thermoplastic materials or thermoset materials (with optional reinforcement) in a shape of the desired impeller. It may be formed in the desired shape using a range of polymer molding processes apparent to those skilled in the art such as, but not limited to, injection molding, compression molding, blow molding, additive manufacturing (liquid bed, powder bed, deposition), or composite layup (autoclave, compression, or liquid molding). To simplify the mold tooling, additional features (e.g., mounting features, flanges, bosses, etc.) may be attached to the polymeric substrate 234 after the block 238, according to an optional block 239. Such features may be attached by bonding using a suitable adhesive. Following the block 238 (or the optional block 239), the outer surfaces of the polymeric substrate 234 which are selected for plating with metallic plating layer(s) 236 may be suitably activated and metallized according to a next block 240. Activation and metallization of the selected surfaces of the polymeric substrate 234 may be carried out using well-established methods in the industry and may result in metallic (conductive) surfaces being formed on the treated surfaces of the polymeric substrate 234, allowing the subsequent deposition of the metallic plating layer(s) 236 thereon.

Following the block 240, one or more metallic plating layers 236 may be deposited on the activated/metallized surfaces of the polymeric substrate 234 according to a next block 242. Deposition of the metallic plating layer(s) 236 may be carried out using metal deposition methods apparent to those skilled in the art such as, but not limited to, electroplating, electroless plating, or electroforming. If desired, masking of selected surfaces of the polymeric substrate 234 may be employed to yield different thicknesses of the metallic plating layer 236, or no plating on the selected areas, as will be understood by those skilled in the art. In addition, if desired, a customized metallic plating layer thickness profile on the surfaces of the polymeric substrate 234 may be achieved using tailored racking tools (e.g., shields, thieves, conformal anodes, etc.), as will be understood by those skilled in the art. Customization of the thickness profile of the metallic plating layer(s) 236 by masking and/or by the use of tailored racking tools may allow for optimization of desired properties (e.g., structural support, surface characteristics, etc.) of the impeller 230, without adding undue weight to the impeller to accommodate each of the desired properties.

As an alternative approach to fabricate the plated polymeric impeller 230, the polymeric substrate 234 may be formed in two or more segments according to a block 244, as shown. The segments of the polymeric substrate 234 may be formed in desired shapes from the above-described thermoplastic or thermoset materials (with optional reinforcement) using one or more of the polymer molding processes described above. Following the block 244, the polymer segments may be joined to form the full-scale polymeric substrate 234, according to a next block 246, as shown. Joining of the polymer segments may be achieved using conventional processes such as, but not limited to, welding (ultrasonic, laser, friction, friction-stir, traditional, etc.), adhesive bonding, or formation of mitered joints (with or without adhesive), as will be apparent to those skilled in the art. Upon completion of the block 246, selected surfaces of the polymeric substrate 234 may then be suitably activated and metallized (block 240) and one or more metallic plating layers 236 may be deposited on the activated/metallized surfaces (block 242), according to the activation/metallization and metal deposition processes above.

As another alternative fabrication method, selected surfaces of each of the polymer segments formed by the block 244 may be activated and metallized (block 240) and one or more metallic plating layers 236 may be deposited on the activated/metallized surfaces of the polymer segments (block 242), using the activation/metallization methods and metal deposition methods described above. The plated segments may then be bonded together to form the full-scale plated polymeric impeller 230 according to the block 248, as shown. Bonding of the plated segments may be achieved using transient liquid phase (TLP) bonding, as will be understood by those skilled in the art.

Once the plated polymeric impeller 230 is formed by one of the above-described methods, it may be further processed according to optional blocks 249 and/or 250, as shown. For example, additional features (e.g., bosses, inserts, etc.) may be attached to the impeller 230 according to the optional block 249. Attachment of such additional features may be achieved using a suitable adhesive, a mechanical fastener (e.g., rivets, bolts, etc.), or another bonding process. In addition, selected surfaces of the impeller 230 may be coated with one or more polymeric materials according to the optional block 250. Coating of the plated polymeric impeller 230 with a polymeric material may be achieved using conventional processes such as, but not limited to, spray coating or dip coating. In addition, coating of the impeller 230 with a polymeric material may provide a lightweight, stiff, and strong polymeric-appearing (non-conductive) product.

From the foregoing, it can therefore be seen that the present disclosure can find industrial applicability in situations which may benefit from lightweight and high-strength impeller constructions. The plated polymeric impeller construction as disclosed herein may provide lightweight and high-strength alternatives for existing impeller material constructions. In addition, cost-savings may be realized by replacing traditional impellers with plated polymeric impellers due to the increased ease of production of plated polymeric impellers (less time, tools, and setup required for fabrication) as well as decreased transportation weights. Schedule savings may also be realized given the high-throughput polymer molding and plating processes disclosed herein. Even further, complex impeller geometries may be accessed by forming the impeller in segments and later joining them according to the fabrication methods disclosed herein. The technology disclosed herein may have applicability in a wide range of areas such as, but not limited to, pump design and power generation.

Plating of Polymeric Gears for Improved Durability

Gears are toothed rotating machine parts that mesh with other toothed parts to transmit motion or torque or to change speed or direction. They may be formed out of high-strength metals or alloys for high-strength applications, or they may be formed out of polymeric materials for low-strength applications. However, metallic gears may be expensive to produce. In contrast, polymeric gears may be lightweight and less expensive to manufacture than metallic gears, but they may lack sufficient durability to sustain damage in some operating environments. Such damage may include shearing of gear teeth, spline damage due to over-torque, and wear from abrasive materials such as sand. In addition, for some medium-load applications, metallic gears may be too strong and expensive to produce, whereas polymeric gears may be too low in strength. Clearly, there is a need for lightweight and high-strength gears that may be manufactured at relatively low costs.

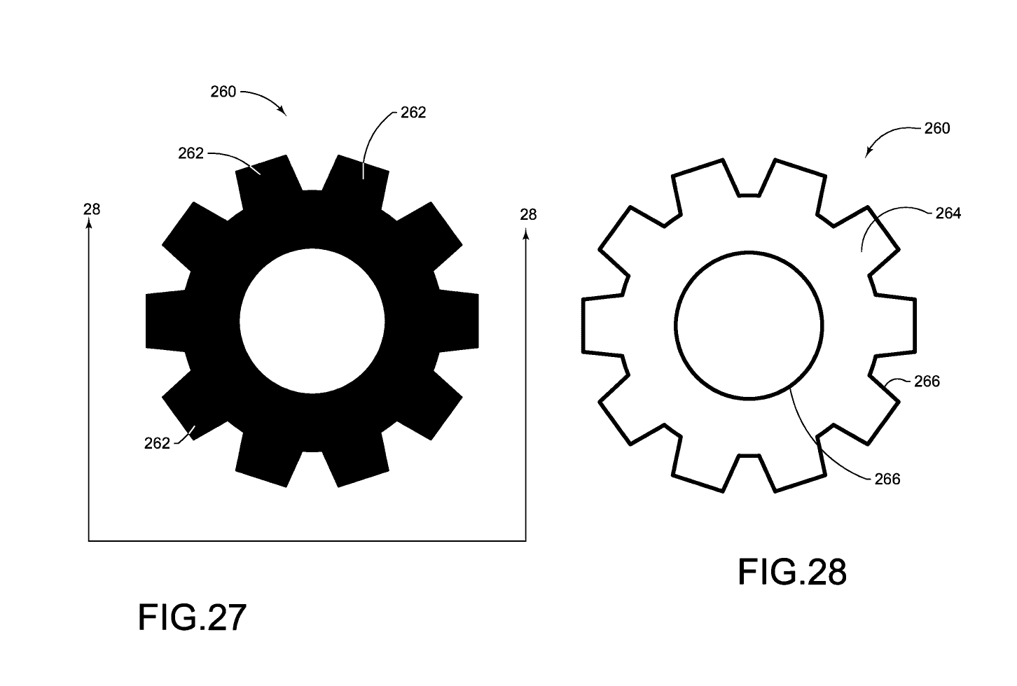

Referring now to FIGS. 27 and 28, a plated polymeric gear 260 is shown. The plated polymeric gear 260 may be a rotating machine part and it may have teeth 262 which may mesh with another toothed part to induce motion or to change speed or direction in a range of applications. Depending on the application, the structure of the plated polymeric gear 260 may deviate from the exemplary structure shown in FIGS. 27 and 28. For example, it may be various types of gears such as, but not limited to, helical gears, spur gears, internal gears, rack and pinion gears, face gears, herringbone (double helical) gears, and bi-level gears. Importantly, by virtue of its plated polymeric construction (see further details below), it may be higher in strength and durability than all-polymeric gears and it may be lighter in weight than all-metallic gears. In addition, it may be less expensive to produce than all-metallic gears.

The plated polymeric construction of the gear 260 is best shown in FIG. 28. In particular, the plated polymeric gear 260 may consist of a polymeric substrate 264 having one or more metallic plating layers 266 deposited on one or more of its outer surfaces. The polymeric substrate 264 may be formed in the shape of the desired gear component (see further details below). As one possibility, the polymeric substrate 264 may have one or more metallic plating layers 266 applied to all of its outer surfaces, as shown in FIG. 28. As another possibility, the metallic plating layer(s) 266 may be deposited on selected outer surfaces of the polymeric substrate 264 according to the strength requirements of the gear 260. In any event, the plated polymeric gear 260 may have advantageous properties of both polymeric components (lightweight, readily moldable into a variety of shapes, inexpensive to produce, etc.) and metallic components (high-strength, high durability, high wear-resistance, etc.).

The polymeric substrate 264 may be formed from a thermoplastic material or a thermoset material, either of which may be optionally reinforced with one or more types of reinforcing materials such as, but not limited to, carbon or glass. Suitable thermoplastic materials may include, but are not limited to, polyetherimide (PEI), thermoplastic polyimide, polyether ether ketone (PEEK), polyether ketone ketone (PEKK), polysulfone, nylon, polyamide, polyphenylene sulfide, polyester, polyimide, and combinations thereof. Suitable thermoset materials may include, but are not limited to, condensation polyimides, addition polyimides, epoxy cured with aliphatic and/or aromatic amines and/or anhydrides, cyanate esters, phenolics, polyesters, polybenzoxazine, polyurethanes, polyacrylates, polymethacrylates, silicones (thermoset), and combinations thereof.

The metallic plating layer(s) 266 may consist of one or more metals selected from a variety of pure metal and alloy deposits including, but not limited to, nickel, cobalt, copper, zinc, nickel-cobalt, nickel-tungsten, nickel-phosphorous, nickel-boron, and combinations thereof. The metallic plating layer 266 may have an average thickness in the range of about 0.0001 inches (about 0.0025 mm) to about 0.05 inches (about 1.3 mm), with localized thicknesses varying from about 0.0001 inches (about 0.0025 mm) to about 0.1 inches (about 2.5 mm).

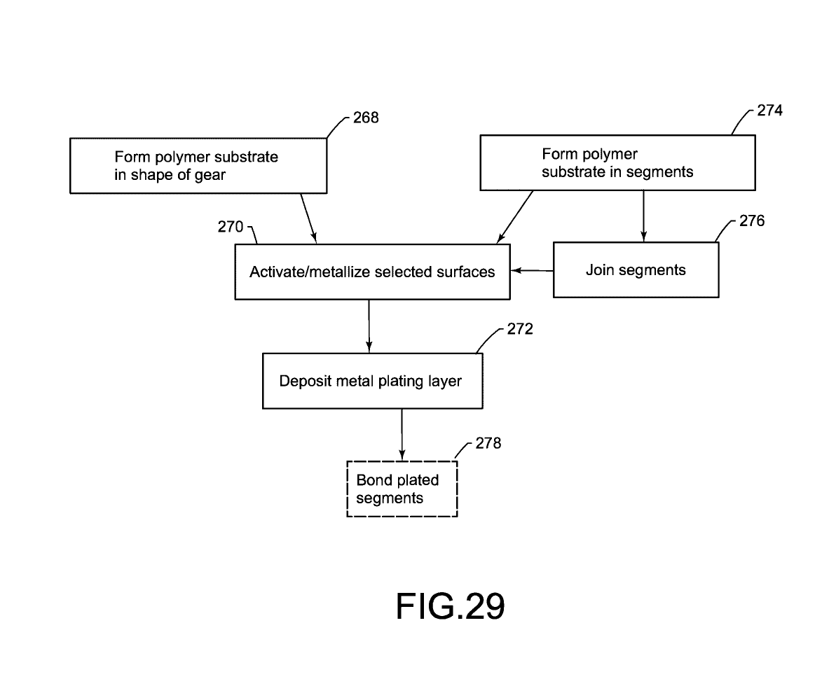

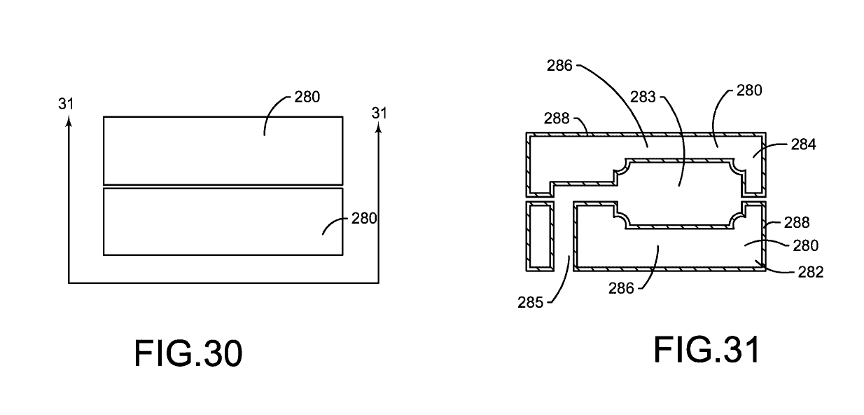

Methods for fabricating the plated polymeric gear 260 are shown in FIG. 29. Beginning with a first block 268, the polymeric substrate 264 may be formed from selected thermoplastic materials or thermoset materials (with optional reinforcement) in a shape of the desired gear. It may be formed in the desired shape using a range of polymer molding processes apparent to those skilled in the art such as, but not limited to, injection molding, compression molding, blow molding, additive manufacturing (liquid bed, powder bed, deposition), or composite layup (autoclave, compression, or liquid molding). Following the block 268, the outer surfaces of the polymeric substrate 264 which are selected for plating with metallic plating layer(s) 266 may be suitably activated and metallized according to a next block 270. Activation and metallization of the selected outer surfaces of the polymeric substrate 264 may be carried out using well-established methods in the industry and may result in metallic (conductive) surfaces being formed on the treated surfaces of the polymeric substrate 264, allowing the subsequent deposition of the metallic plating layer(s) 266 thereon.

Following the block 270, one or more metallic plating layers 266 may be deposited on the activated/metallized surfaces of the polymeric substrate 264 according to a next block 272. Deposition of the metallic plating layer(s) 266 may be carried out using metal deposition methods apparent to those skilled in the art such as, but not limited to, electroplating, electroless plating, or electroforming. If desired, masking of selected outer surfaces of the polymeric substrate 264 may be employed to yield different thicknesses of the metallic plating layer 266, or no plating on selected outer surfaces, as will be understood by those skilled in the art. In addition, if desired, a customized metallic plating layer thickness profile on the surfaces of the polymeric substrate 264 may be achieved using tailored racking tools (e.g., shields, thieves, conformal anodes, etc.), as will be understood by those skilled in the art. Customization of the thickness profile of the metallic plating layer(s) 266 by masking and/or by the use of tailored racking tools may allow for optimization of desired properties (e.g., load-carrying capacity, structural support, surface characteristics, etc.) of the plated polymeric gear 260, without adding undue weight to the gear to accommodate each of the desired properties.

As an alternative approach to fabricate the plated polymeric gear 260, the polymeric substrate 264 may be formed in two or more segments according to a block 274, as shown. The segments of the polymeric substrate 264 may be formed in the desired shapes from thermoplastic or thermoset materials (with optional reinforcement) using one or more of the polymer molding processes described above. Following the block 274, the polymer segments may be joined to form the full-scale polymeric substrate 264, according to a next block 276, as shown. Joining of the polymer segments may be achieved using conventional processes such as, but not limited to, welding (ultrasonic, laser, friction, friction-stir, traditional, etc.), adhesive bonding, or formation of mitered joints (with or without adhesive), as will be apparent to those skilled in the art. Upon completion of the block 276, selected outer surfaces of the polymeric substrate 264 may then be suitably activated and metallized (block 270) and one or more metallic plating layers 266 may be deposited on the activated/metallized surfaces (block 272), according to the activation/metallization and metal deposition processes above.

As another alternative fabrication method, selected outer surfaces of each of the polymer segments formed by the block 274 may be activated and metallized (block 270) and one or more metallic plating layers 266 may be deposited on the activated/metallized outer surfaces of the polymer segments (block 272), using the activation/metallization methods and metal deposition methods described above. The plated segments may then be bonded together to form the full-scale plated polymeric gear 260 according to the block 278, as shown. Bonding of the plated segments may be achieved using transient liquid phase (TLP) bonding, as will be understood by those skilled in the art.

From the foregoing, it can therefore be seen that the present disclosure can find industrial applicability in situations which may benefit from lightweight and high-strength gear constructions. The plated polymeric gear construction as disclosed herein may provide lightweight and high-strength alternatives for existing gear constructions. More specifically, plated polymeric gears may exhibit improved wear resistance and may be substantially higher in strength and durability than all-polymeric gears. In addition, they may be lighter in weight and more cost-effective to manufacture than all-metallic gears. Plated polymeric gears may find use in many situations such as, for example, medium-load applications in which polymeric gears are too weak and metallic gears are too strong. The technology disclosed herein may have applicability in a wide range of areas such as, but not limited to, automotive, space exploration, handheld device, and toy applications.

Plated Polymeric Casting Molds and Tooling

Die casting is a widely adopted method for manufacturing metallic components by injecting molten metal into a mold cavity formed between two dies and allowing the molten metal to cool and solidify in a desired shape. One die (the “cover die half”) may contain a channel for allowing the flow of the molten metal into the mold cavity and the other die (“ejector die half”) may have ejector pins for ejecting the casting product after cooling. The die casting method may provide casting products in a range of geometries and continues to be widely employed for component fabrication in various industries such as the automotive and aerospace industries. However, casting dies and other casting tools may have complex shapes and may be expensive to manufacture. For example, casting dies manufactured out of high speed tool steel may cost more than 200,000 dollars to produce in some cases. In addition, once the casting dies are produced, they may be susceptible to damage and may wear out over time. Clearly, there is a need for inexpensive alternatives for casting dies and casting tooling.

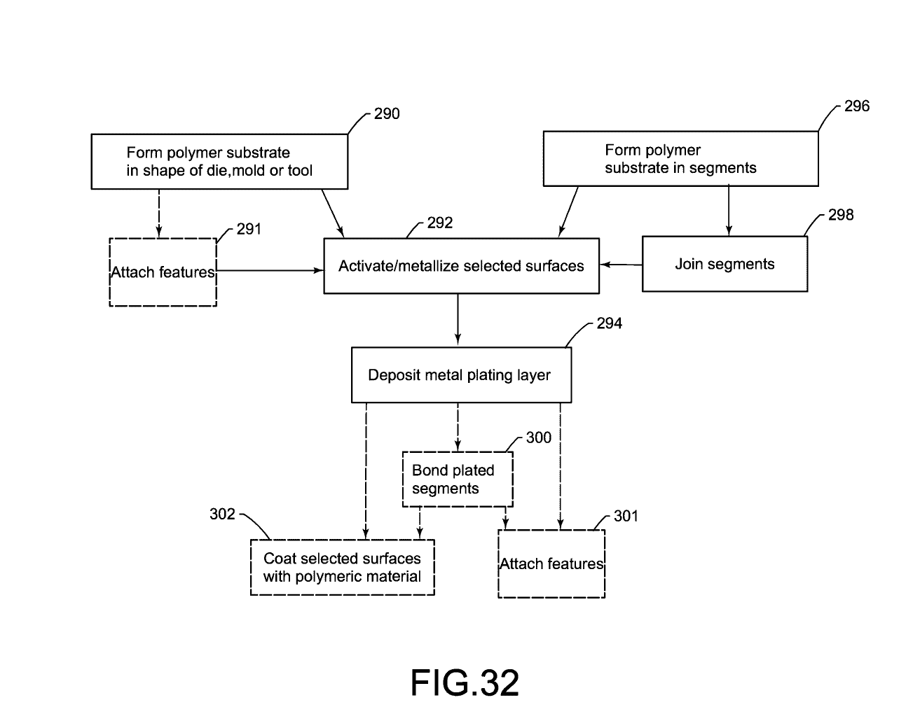

Referring now to FIGS. 31 and 32, plated polymeric casting dies 280 are shown. The plating polymeric casting dies 280 may be employed for die casting processes for the production of castings having desired shapes. The dies 280 may include a cover die half 282 and an ejector die half 284, with a mold cavity 283 in the shape of the desired casting product formed between the cover die half 282 and the ejector die half 284 when suitably assembled, as best shown in FIG. 31. The cover die half 282 may also contain a channel 285 for allowing molten metal to flow into the mold cavity 283 and the ejector die half 284 may contain ejector pins (not shown) for ejecting the casting product from the mold cavity 283. As will be appreciated by those skilled in the art, the plated polymeric casting dies 280 may have a variety of shapes and sizes depending on the application and the desired casting product, and in practice, may have various alternative structures and additional features which may deviate substantially from the exemplary structures shown in FIGS. 31 and 32. In any event, by virtue of their plated polymeric construction (see further details below), the plated polymeric casting dies 280 may be lightweight and high in strength, yet less expensive to manufacture than casting dies of similar size and shape formed from traditional materials and processes (e.g., tool steel dies, etc.).

The plated polymeric construction of the dies 280 are best shown in FIG. 31. In particular, the plated polymeric dies 280 may consist of a polymeric substrate 286 having one or more metallic plating layers 288 deposited on one or more of its surfaces. As one possibility, the polymeric substrate 286 may have one or more metallic plating layers 288 applied to all of its exposed surfaces, as shown in FIG. 31. As another possibility, the metallic plating layer(s) 288 may be deposited on selected surfaces of the polymeric substrate 286 to impart selected regions of the dies 280 with increased strength and durability.

The polymeric substrate 286 may be formed from a thermoplastic or a thermoset material, either of which may be optionally reinforced with one or more types of reinforcing materials such as, but not limited to, carbon or glass. Suitable thermoplastic materials may include, but are not limited to, polyetherimide (PEI), thermoplastic polyimide, polyether ether ketone (PEEK), polyether ketone ketone (PEKK), polysulfone, nylon, polyamide, polyphenylene sulfide, polyester, polyimide, and combinations thereof. Suitable thermoset materials may include, but are not limited to, condensation polyimides, addition polyimides, epoxy cured with aliphatic and/or aromatic amines and/or anhydrides, cyanate esters, phenolics, polyesters, polybenzoxazine, polyurethanes, polyacrylates, polymethacrylates, silicones (thermoset), and combinations thereof.

The metallic plating layer(s) 288 may consist of one or more metals selected from nickel, cobalt, copper, iron, gold, silver, palladium, rhodium, chromium, zinc, tin, cadmium, and alloys with any of the foregoing elements comprising at least 50 wt. % of the alloy, and combinations thereof. The metallic plating layer 288 may have a thickness in the range of about 0.004 inches (about 0.10 mm) to about 0.030 inches (about 0.76 mm), with localized thicknesses in the range of about 0.001 inches (0.025 mm) to about 0.050 inches (about 1.27 mm), but other thicknesses may also apply depending on the application. This range of metallic plating layer thicknesses may provide the casting dies 280 with desired properties such as erosion resistance, impact resistance, and resistance to foreign object damage. Furthermore, this range of metallic plating layer thicknesses may also provide the option to finish the surfaces of the dies 280 more aggressively to meet tight tolerances and/or surface finish requirements.

Various methods for fabricating a plated polymeric die 280 (e.g., a cover die half, an ejector die half, etc.) or other die casting molds or tooling are shown in FIG. 32. Beginning with a first block 290, the polymeric substrate 286 may be formed from selected thermoplastic materials or thermoset materials (with optional reinforcement) in a shape of the desired die, mold, or casting tooling. It may be formed in the desired shape using a range of polymer molding processes apparent to those skilled in the art such as, but not limited to, injection molding, compression molding, blow molding, additive manufacturing (liquid bed, powder bed, deposition), or composite layup (autoclave, compression, or liquid molding). To simplify the mold tooling, additional features (e.g., mounting features, flanges, bosses, etc.) may be attached to the polymeric substrate 286 after the block 290, according to an optional block 291. Such features may be attached by bonding using a suitable adhesive. Following the block 290 (or the optional block 291), surfaces of the polymeric substrate 286 which are selected for plating with the metallic plating layer 288 may be suitably activated and metallized according to a next block 292. Activation and metallization of the selected surfaces of the polymeric substrate 286 may be carried out using well-established methods in the industry and may result in metallic (conductive) surfaces being formed on the treated surfaces of the polymeric substrate 286, allowing the subsequent deposition of the metallic plating layer(s) 288 thereon.

Following the block 292, one or more metallic plating layers 288 may be deposited on the activated/metallized surfaces of the polymeric substrate 286 according to a next block 294. Deposition of the metallic plating layer(s) 288 may be carried out using metal deposition methods apparent to those skilled in the art such as, but not limited to, electroplating, electroless plating, or electroforming. If desired, masking of selected surfaces of the polymeric substrate 286 may be employed to yield different thicknesses of the metallic plating layer(s) 288, or no plating on the selected areas, as will be understood by those skilled in the art. In addition, if desired, a customized metallic plating layer thickness profile on the surfaces of the polymeric substrate 286 may be achieved using tailored racking tools (e.g., shields, thieves, conformal anodes, etc.), as will be understood by those skilled in the art. Such customization of the thickness profile of the metallic plating layer(s) 288 by masking and/or by the use of tailored racking tools may allow for the optimization of desired properties (e.g., structural support, surface characteristics, etc.) of the die 280, without adding undue weight to the die 280 to accommodate each of the desired properties.

As an alternative method to fabricate the plated polymeric die 280, the polymeric substrate 286 may be formed in two or more segments according to a block 296, as shown. The segments of the polymeric substrate 286 may be formed in desired shapes from thermoplastic or thermoset materials (with optional reinforcement) using one or more of the polymer molding processes described above. Following the block 296, the polymer segments may be joined to form the full-scale polymeric substrate 286, according to a next block 298, as shown. Joining of the polymer segments may be achieved using conventional processes such as, but not limited to, welding (ultrasonic, laser, friction, friction-stir, traditional, etc.), adhesive bonding, or formation of mitered joints (with or without adhesive), as will be apparent to those skilled in the art. Upon completion of the block 298, selected surfaces of the polymeric substrate 286 may then be suitably activated and metallized (block 292) and one or more metallic plating layers 288 may be deposited on the activated/metallized surfaces (block 294), according to the activation/metallization and metal deposition processes described above.

As another alternative fabrication method, selected surfaces of each of the polymer segments formed by the block 296 may be activated and metallized (block 292) and one or more metallic plating layers 288 may be deposited on the activated/metallized surfaces of the polymer segments (block 294), using the activation/metallization methods and metal deposition methods described above. The plated segments may then be bonded together to form the full-scale plated polymeric die 280 according to the block 300, as shown. Bonding of the plated segments may be achieved using transient liquid phase (TLP) bonding, as will be understood by those skilled in the art.

Once the plated polymeric die 280 is formed by one of the above-described methods, it may be further processed according to optional blocks 301 and/or 302, as shown. For example, additional features (e.g., bosses, inserts, etc.) may be attached to the die 280 according to the optional block 301. Attachment of such additional features may be achieved using a suitable adhesive, a mechanical fastener (e.g., rivets, bolts, etc.), or another bonding process. In addition, selected surfaces of the die 280 may be coated with one or more polymeric materials according to the optional block 301. Coating of the plated polymeric die 280 with the polymeric material may be achieved using conventional processes such as, but not limited to, spray coating or dip coating. In addition, coating of the casting die 280 with the polymeric material may provide a lightweight, stiff, and strong polymeric-appearing (non-conductive) casting die.

The plated polymeric construction disclosed herein for the casting dies 280 may also be employed for the fabrication of other casting mold structures or casting tooling, as will be appreciated by those skilled in the art.

From the foregoing, it can therefore be seen that the present disclosure can find industrial applicability in situations which may benefit from lightweight, high-strength, and inexpensive casting dies, casting molds, and casting tooling. The plated polymeric casting dies, molds, and tooling as disclosed herein may provide lighter-weight and lower-cost alternatives for traditional casting die, mold, and tool material constructions (e.g., tool steel, etc.). The plated polymeric casting dies, molds, and toolings may be easily fabricated with inexpensive materials and they may be plated for longer operative lifetimes. In addition, if desired, complex geometries may be accessed directly or by forming the die, mold, or tool in segments which are later joined according to the methods disclosed herein. Schedule saving may also be realized given the high-throughput polymer molding and plated processes described herein. The technology as disclosed herein may find industrial applicability in a wide range of areas such as, but not limited to, automotive, aerospace, power generation, and pump manufacturing industries.

Hollow Bearing Ball Produced by Plating

Ball bearings are used in many types of equipment and machines to reduce friction. Ball bearings transmit loads through bearing balls contained between two separate moving parts and reduce friction. In general, bearing balls are solid and are usually fabricated from heavy materials such as metals or silicon nitride (Si₃N₄). However, some lower-loaded applications may benefit from lighter-weight bearing ball constructions. Clearly, there is a need for lightweight and high-strength bearing ball constructions.

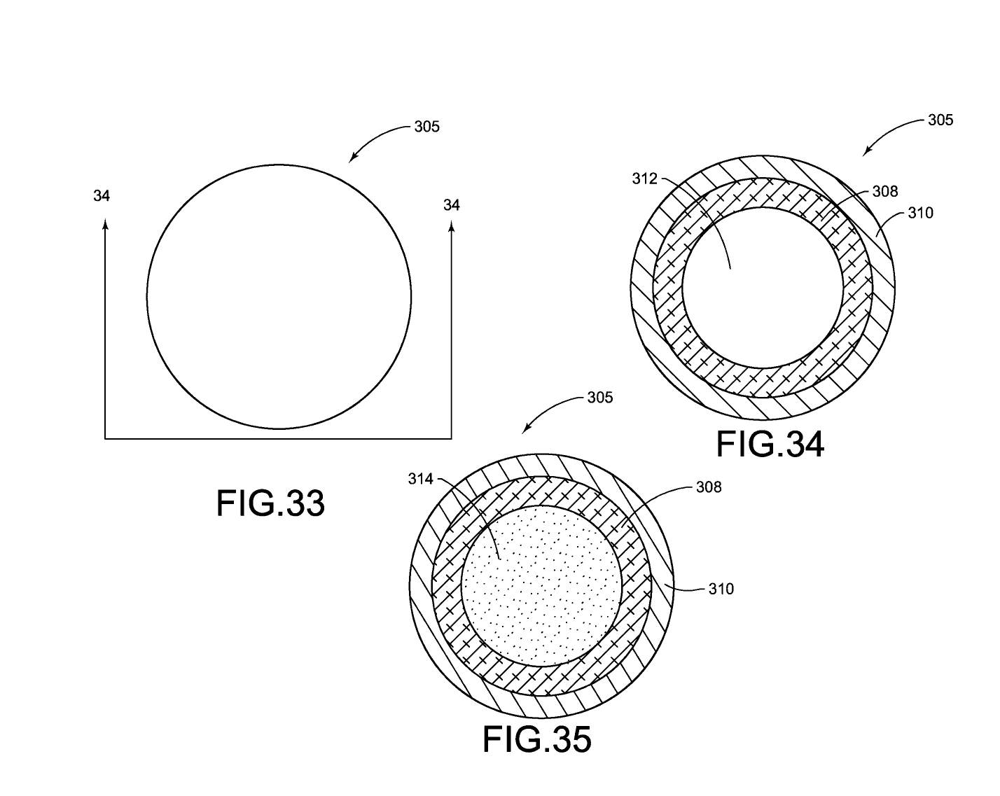

Referring now to FIGS. 33 and 34, a plated bearing ball 305 is shown. The plated bearing ball 305 may be employed for use in a ball bearing for a range of applications, as will be understood by those of ordinary skill in the art. The plated bearing ball 305 may be spherical in shape and it may have a range of diameters depending on its intended application. Importantly, by virtue of its plated hollow construction, it may be both light in weight and high in strength, offering an alternative to heavier conventional bearing balls.

The plated hollow construction of the plated bearing ball 305 is shown in FIG. 34. In particular, the plated bearing ball 305 may consist of a hollow sphere 308 plated on its outer surface with one or more metallic plating layers 310, as shown. In addition, it may have a hollow cavity 312 at its core. The hollow sphere 308 may be formed from moldable and lightweight polymeric materials (see further details below). Alternatively, when increased rigidity is required, the hollow sphere 308 may be formed from metallic materials. As an alternative arrangement, such as when increased rigidity and structural support is required, the hollow cavity 312 may be filled with an internal support structure 314, as best shown in FIG. 35. The internal support structure 314 may consist of lightweight foam or another type of support structure.

If the hollow sphere 308 is formed from polymeric materials, it may be formed from a thermoplastic or a thermoset material, either of which may be optionally reinforced with one or more types of reinforcing materials such as, but not limited to, carbon or glass. Suitable thermoplastic materials may include, but are not limited to, polyetherimide (PEI), thermoplastic polyimide, polyether ether ketone (PEEK), polyether ketone ketone (PEKK), polysulfone, nylon, polyamide, polyphenylene sulfide, polyester, polyimide, and combinations thereof. Suitable thermoset materials may include, but are not limited to, condensation polyimides, addition polyimides, epoxy cured with aliphatic and/or aromatic amines and/or anhydrides, cyanate esters, phenolics, polyesters, polybenzoxazine, polyurethanes, polyacrylates, polymethacrylates, silicones (thermoset), and combinations thereof.

The metallic plating layer(s) 310 may consist of nickel, cobalt, copper, iron, gold, silver, palladium, rhodium, chromium, zinc, tin, cadmium, and alloys with any of the foregoing elements comprising at least 50 wt. % of the alloy, and combinations thereof. The metallic plating layer 310 may have a high thickness in the range of about 2 mm to about 13 mm, but other metallic plating layer thicknesses may also be used depending on the application.

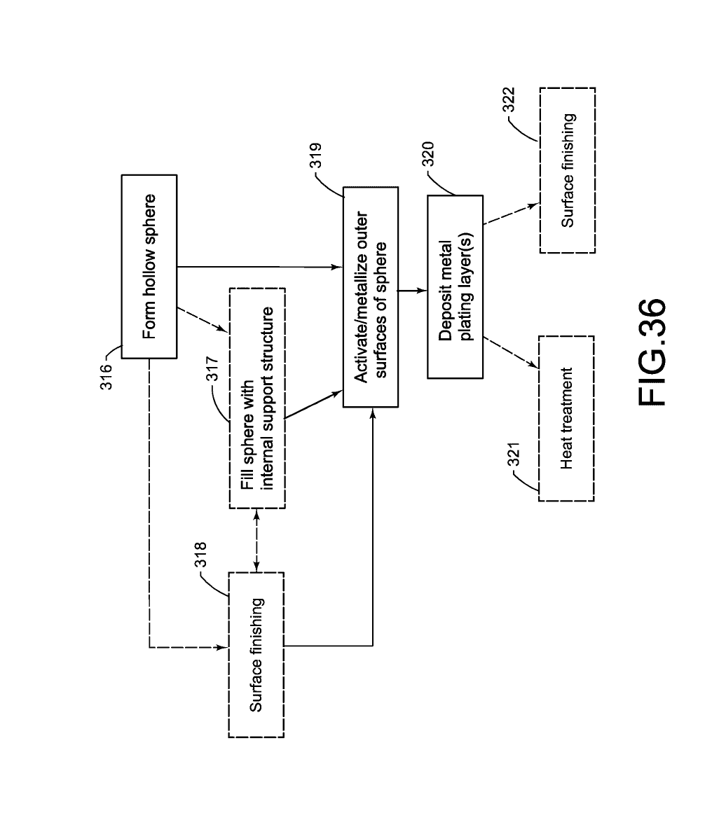

A series of steps which may be performed to fabricate the plated bearing ball 305 are shown in FIG. 36. Beginning with a first block 316, the hollow sphere 308 may be formed from polymeric materials (i.e., thermoplastic or thermoset materials with optional reinforcement) or from metallic materials when increased structural support is required. If the hollow sphere 308 is formed from polymeric materials, it may be formed in a spherical shape with a desired diameter using a range of polymer molding processes apparent to those skilled in the art such as, but not limited to, injection molding, blow molding, or additive manufacturing (liquid bed, powder bed, deposition). If the hollow sphere 308 is formed form metallic materials, it may be formed in a spherical shape with a desired diameter using an additive manufacturing technique, as will be apparent to those skilled in the art. Optionally, such as when increased rigidity and structural support is required, the hollow sphere 308 may be filled with the internal support structure 314 according to a block 317, as shown. As described above, the internal support structure 314 may be a foam to provide slightly increased rigidity or another support structure to provide more rigidity. As one possibility, the support structure may be introduced into the body of the hollow sphere 308 during its formation by additive manufacturing. In addition, the hollow sphere 308 may be surface finished according to an optional block 318. Surface finishing of the hollow sphere may be achieved using a suitable surface finishing method apparent to those skilled in the art such as, but not limited to, grinding and lapping.

Following the block 316 (or the optional blocks 317 and/or 318), the outer surfaces of the hollow sphere 308 may be suitably activated and metallized according to a next block 319. Activation and metallization of the outer surfaces of the hollow sphere 308 may be carried out using well-established methods in the industry and may result in metallic (conductive) surfaces being formed on the treated surfaces of the polymer, allowing the subsequent deposition of the metallic plating layer(s) 310 thereon. If, however, the hollow sphere 308 is formed from metallic materials, the block 319 may be omitted. Following the block 319, one or more metallic plating layers 310 may be deposited on the outer surfaces of the hollow sphere 308 according to a next block 320. Deposition of the metallic plating layer(s) 310 may be carried out using metal deposition methods apparent to those skilled in the art such as, but not limited to, electroplating, electroless plating, or electroforming. In this way, the hollow sphere 308 may function as a captive mandrel for the deposition of the metallic plating layer(s).

Upon completion of the block 320, the plated bearing ball 305 may be provided. If desired, the plated bearing ball 305 may be further treated according to optional blocks 321 and/or 322, as shown. For example, the plated bearing ball 305 may be heat treated according to the block 321 to raise certain properties, such as hardness, to a required level. In addition, the surfaces of the plated bearing ball 305 may be finished according to the block 322. Surface finishing of the plated bearing ball 305 may be achieved using conventional finishing methods apparent to those skilled in the art such as, but not limited to, grinding and lapping.

From the foregoing, it can therefore be seen that the present disclosure can find applicability in situations which may benefit from lightweight and high-strength bearing balls. The hollow construction of the plated bearing balls as disclosed herein may provide lightweight alternatives for heavy conventional bearing balls. The metallic plating layer may be sufficiently high in strength and fatigue capability for a range of applications. The technology as disclosed herein may find industrial applicability in a wide range of areas such as, but not limited to, sporting equipment, construction, and electronic devices.

Compliant Mechanisms with Improved Life

Compliant mechanisms rely on the deflection (i.e., displacement of a body under load) of flexible members to transmit motion, force, or energy. In contrast to traditional rigid-body mechanisms which use rigid links connected at moveable joints, compliant mechanisms rely on the elasticity (non-permanent deformability) of materials to perform a function. One advantage of complaint mechanisms over their rigid-body counterparts is a reduction in the number of parts which may simplify manufacturing complexity and associated assembly time and costs. The reduced or eliminated need for joints in compliant mechanisms also may result in reduced part wear and the need for part lubrication as well as increased mechanism precision. Because many compliant mechanisms are fabricated from deformable polymeric materials, repeated flexion of the flexible members may lead to crazing of the flexible members and eventual failure of the compliant mechanism. In some cases, this may limit the operative lifetime or prevent the use of compliant mechanisms in some engineering applications. Clearly, there is a need for compliant mechanisms constructions with improved wear resistance and structural resilience.

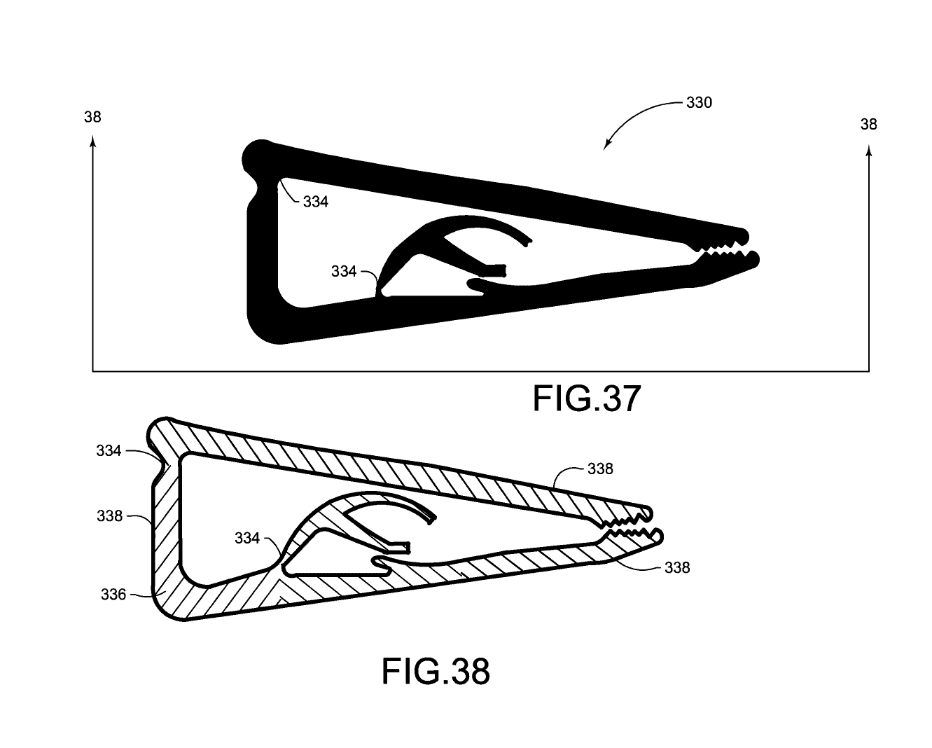

Referring now to FIGS. 37 and 38, a plated polymeric compliant mechanism 330 is shown. The plated polymeric compliant mechanism 330 may be any type of complaint mechanism and may have a variety of geometries and sizes depending on its design. The compliant mechanism 330 may have one or more flexible portions 334 which may be deflected to transmit motion, energy, or force. Importantly, by virtue of its plated polymeric construction (see further details below), the compliant mechanism 330 may exhibit improved strength and wear resistance over traditional (i.e., polymeric) complaint mechanisms.

The plated polymeric construction of the compliant mechanism 330 is best shown in FIG. 38. In particular, it may consist of a polymeric substrate 336 plated on one or more of its outer surfaces with one or more metallic plating layers 338, as shown. The polymeric substrate 336 may be formed in the shape of the desired complaint mechanism. As one possible arrangement, the polymeric substrate 336 may be plated on all of its outer surfaces with the flexible portions 334 having thicker metallic plating layers to improve the structural integrity and/or operative lifetime of the compliant mechanism 330. In this way, properties of the plated polymeric compliant mechanism 330 with respect to the force-deflection response may be optimized without adding undue weight to the compliant mechanism. As additional possibilities, the polymeric substrate 336 may be evenly plated on all of its outer surfaces with one or more metallic plating layers 338, as shown in FIG. 38, or it may be plated with one or more metallic plating layers 338 on selected outer surfaces to impart selected regions of the compliant mechanism with increased strength.

The polymeric substrate 336 may be formed from a thermoplastic material or a thermoset material, either of which may be optionally reinforced with one or more types of reinforcing materials such as, but not limited to, carbon or glass. Suitable thermoplastic materials may include, but are not limited to, polyetherimide (PEI), thermoplastic polyimide, polyether ether ketone (PEEK), polyether ketone ketone (PEKK), polysulfone, nylon, polyamide, polyphenylene sulfide, polyester, polyimide, and combinations thereof. Suitable thermoset materials may include, but are not limited to, condensation polyimides, addition polyimides, epoxy cured with aliphatic and/or aromatic amines and/or anhydrides, cyanate esters, phenolics, polyesters, polybenzoxazine, polyurethanes, polyacrylates, polymethacrylates, silicones (thermoset), and combinations thereof.

The metallic plating layer(s) 338 may consist of one or more metals selected from nickel, cobalt, copper, iron, gold, silver, palladium, rhodium, chromium, zinc, tin, cadmium, and alloys with any of the foregoing elements comprising at least 50 wt. % of the alloy, and combinations thereof. It may have localized thicknesses in the range of about 0.0005 inches (about 0.0127 mm) to about 0.050 inches (about 1.27 mm), but other thickness ranges may also apply depending on the application.

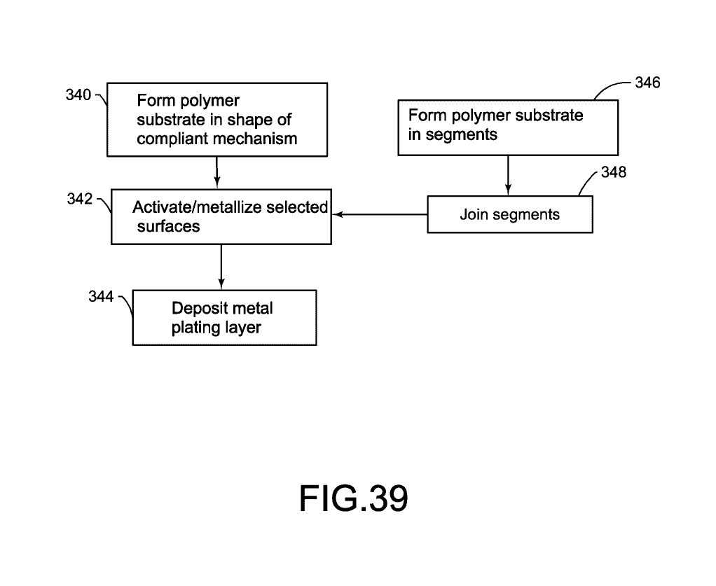

Different methods for fabricating the plated polymeric compliant mechanism 330 are shown in FIG. 39. Beginning with a first block 340, the polymeric substrate 336 may be formed from selected thermoplastic or thermoset materials (with optional reinforcement) in a shape of the desired compliant mechanism. It be formed in the desired shape using a range of polymer molding processes apparent to those skilled in the art such as, but not limited to, injection molding, compression molding, blow molding, additive manufacturing (liquid bed, powder bed, deposition), or composite layup (autoclave, compression, or liquid molding). Following the block 340, exposed surfaces of the polymeric substrate 336 which are selected for plating with the metallic plating layer 338 may be suitably activated and metallized according to a next block 342. Activation and metallization of the selected outer surfaces of the polymeric substrate 336 may be performed using well-established methods in the industry and may result in metallic (conductive) surfaces being formed on the treated surfaces of the polymeric substrate 336, allowing the subsequent deposition of the metallic plating layer(s) 338 thereon.

Following the block 342, one or more metallic plating layers 338 may be deposited on the activated/metallized surfaces of the polymeric substrate 336 according to a next block 344. Deposition of the metallic plating layer(s) 338 may be carried out using one or more metal deposition methods apparent to those skilled in the art such as, but not limited to, electroplating, electroless plating, electroforming, spray coating, or powder-spray coating. If desired, masking of selected outer surfaces of the polymeric substrate 336 may be employed to yield different thicknesses of the metallic plating layer or no plating on the selected areas, as will be understood by those skilled in the art. In addition, if desired, a customized metallic plating layer thickness profile on the surfaces of the polymeric substrate 336 may be achieved using tailored racking tools (e.g., shields, thieves, conformal anodes, etc.), as will be understood by those skilled in the art. Customization of the thickness profile of the metallic plating layer(s) 338 by masking and/or by the use of tailored racking tools may allow for optimization of desired properties (e.g., strength, wear resistance, force-deflection response, etc.) of the compliant mechanism 330, without adding undue weight to the compliant mechanism 330 to accommodate each of the desired surface properties. In particular, the metallic plating layers 338 on the flexible portions 334 may be selectively thickened to provide these portions with improved wear resistance and crazing resistance in order to increase the operative lifetime of the plated polymeric compliant mechanism 330.

As an alternative approach to fabricate the plated polymeric compliant mechanism 330, the polymeric substrate 336 may be formed in two or more segments according to a block 346, as shown. The segments of the polymeric substrate 336 may be formed in desired shapes from the above-described thermoplastic or thermoset materials (with optional reinforcement) using one or more of the polymer molding processes described above. Following the block 346, the polymer segments may be joined to form the full-scale polymeric substrate 336, according to a next block 348, as shown. Joining of the polymer segments may be achieved using conventional processes such as, but not limited to, welding (ultrasonic, laser, friction, friction-stir, traditional, etc.), adhesive bonding, or formation of mitered joints (with or without adhesive), as will be apparent to those skilled in the art. Upon completion of the block 348, selected outer surfaces of the polymeric substrate 336 may then be suitably activated and metallized (block 342) and one or more metallic plating layers 338 may be deposited on the activated/metallized surfaces (block 344), according to the activation/metallization and metal deposition processes above. Notably, masking and/or tailored racking methods may be employed to selectively thicken the metallic plating layers 338 at the flexible portions 334, as described above.

From the foregoing, it can therefore be seen that the present disclosure can find applicability in situations which may benefit from compliant mechanisms with improved structural resilience and increased operative lifetimes. In particular, the plated polymeric compliant mechanisms as disclosed herein may provide higher-strength alternatives for existing compliant mechanism material constructions (i.e., polymeric materials). Even further, complex geometries for compliant mechanisms may be accessed by forming the compliant mechanism in segments and later joining them together according to the methods disclosed herein. Schedule savings may also be realized given the high-throughput polymer molding and plating processes disclosed herein. The technology as disclosed herein may have industrial applicability in a wide range of areas such as, but not limited to, handheld devices, tools, sporting equipment, and automotive equipment.

Plated Polymeric Heating, Ventilation, Air Conditioning, and Refrigeration Equipment

Heating, ventilation, air conditioning, and refrigeration (HVACR) equipment are widely used to control the temperature and/or humidity of enclosed environments. Examples of HVACR equipment may include, but are not limited to, heaters, hot water heaters, air conditioning units, and refrigerators as well as the various components contained within such equipment such as, but not limited to, heat exchangers, pipes, fittings, fasteners, flanges, pumps, valves, drains, tanks, and filtration equipment. Many types of HVACR equipment may be susceptible to corrosion or erosion due to exposure to seawater, fresh water, bacteria, air, debris, and pollutants and this may cause some HVACR equipment to have reduced operative lifetimes. In addition, many types of HVACR equipment may be fabricated from heavy materials which may make their transportation and repair difficult. Clearly, there is a need for lighter weight constructions for HVACR equipment that have improved resistance to erosion and corrosion.

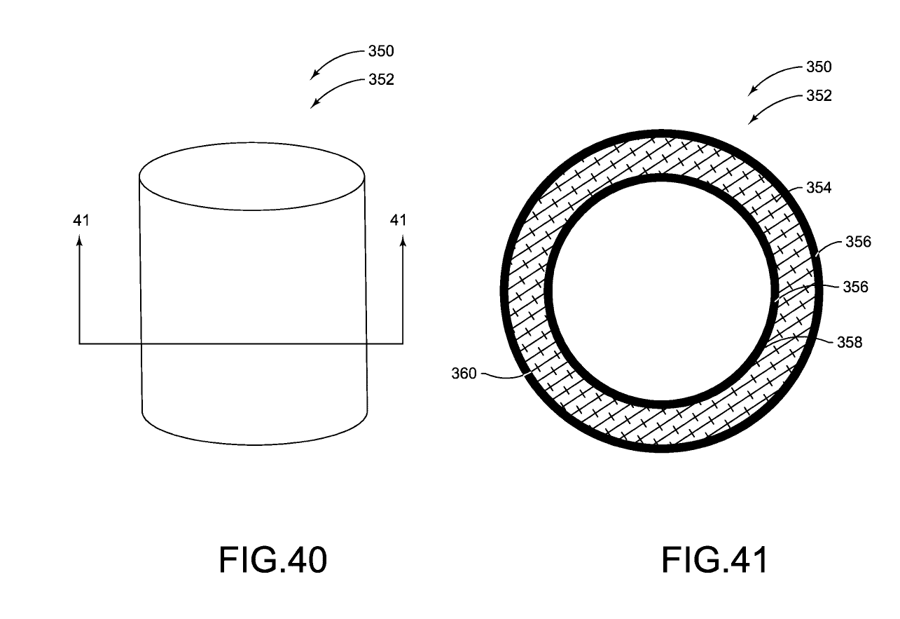

Referring now to FIGS. 40 and 41, a plated polymeric HVACR equipment 350 is shown. The plated polymeric HVACR equipment 350 may be various types of equipment used to control the temperature, humidity, or air quality of an enclosed environment. As one non-limiting example, the plated polymeric HVACR equipment 350 may be a hot water heater case 352, as shown. However, it may be other types of HVACR equipment such as, but not limited to, heaters, ventilators, air conditioning units, and refrigeration units including the components contained within such equipment including, but not limited to, heat exchangers, pipes, fittings, fasteners, flanges, pumps, valves, drains, tanks, structural components, and filtration equipment. As can be appreciated, the plated polymeric HVACR equipment 350 may therefore have any shape and size suitable for its intended use. Importantly, by virtue of its plated polymeric construction (see further details below), the HVACR equipment 350 may be lighter in weight and exhibit improved corrosion and erosion resistance over similarly-dimensioned HVACR equipment formed from traditional materials and processes.

The plated polymeric construction of the HVACR equipment 350 is best shown in cross-section in FIG. 41. In particular, FIG. 41 shows the walls of the hot water heater case 352 with internal components (e.g., heating elements, valves, pipes, etc.) and the back wall removed for clarity purposes. The plated polymeric HVACR equipment 350 may consist of a polymeric substrate 354 plated on one or more of its surfaces with one or more metallic plating layers 356, as shown. The polymeric substrate 354 may be formed in the shape of the desired HVACR equipment, such as the hot water heater case 352 shown. As one possibility, the polymeric substrate 354 may be plated with one or more metallic plating layers 356 both on its interior surface 358 and on its exterior surface 360, as shown. As another possibility, the polymeric substrate 354 may have one or more metallic plating layers 356 only on its interior surface 358 or only on its exterior surface 360, depending on which of its surfaces may be exposed to corrosive and erosive conditions. Alternatively, one or more metallic plating layers 356 may be deposited on selected regions of either or both of the interior surface 358 and the exterior surface 360 of the polymeric substrate 354.

The polymeric substrate 354 may be formed from a thermoplastic material or a thermoset material, either of which may be optionally reinforced with one or more types of reinforcing materials such as, but not limited to, carbon or glass. Suitable thermoplastic materials may include, but are not limited to, polyetherimide (PEI), thermoplastic polyimide, polyether ether ketone (PEEK), polyether ketone ketone (PEKK), polysulfone, polyamide, polyphenylene sulfide, polyester, polyimide, and combinations thereof. Suitable thermoset materials may include, but are not limited to, condensation polyimides, addition polyimides, epoxy cured with aliphatic and/or aromatic amines and/or anhydrides, cyanate esters, phenolics, polyesters, polybenzoxazine, polyurethanes, polyacrylates, polymethacrylates, silicones (thermoset), and combinations thereof. Depending on the molding process used to form the polymeric substrate 354, its thickness may vary. For example, the thickness of the polymeric substrate 354 may range from about 0.050 inches (about 1.27 mm) to about 0.25 inches (about 6.35 mm) if it is formed by injection molding, whereas its thickness may range from about 0.050 inches (about 1.27 mm) to about two inches (about 51 mm) if it is formed by compression molding.

The metallic plating layer(s) 356 may consist of one or more metals selected from titanium, nickel, lead, cobalt, copper, iron, gold, silver, palladium, rhodium, chromium, zinc, tin, cadmium, and alloys with any of the foregoing elements comprising at least 50 wt. % of the alloy, and combinations thereof. In particular, if the metallic plating layer 356 consists of titanium, it may be particularly effective at imparting the plated surfaces of the HVACR equipment 350 with resistance to corrosion and erosion, although other metallic plating layer compositions may have this effect as well. The metallic plating layer 356 may have a thickness in the range of about 0.004 inches (about 0.102 mm) to about 0.040 inches (about 1.02 mm), with localized regions having thicknesses in the range of about 0.001 inches (about 0.025 mm) to about 0.050 inches (about 1.27 mm), but other thickness ranges may also apply. This range of metallic plating layer thicknesses may provide the HVACR equipment 350 with resistance to erosion and/or impact damage. In addition, this range of thicknesses may also offer the option to finish the surfaces of the HVACR equipment 350 more aggressively to meet tight tolerances and/or surface finish requirements.

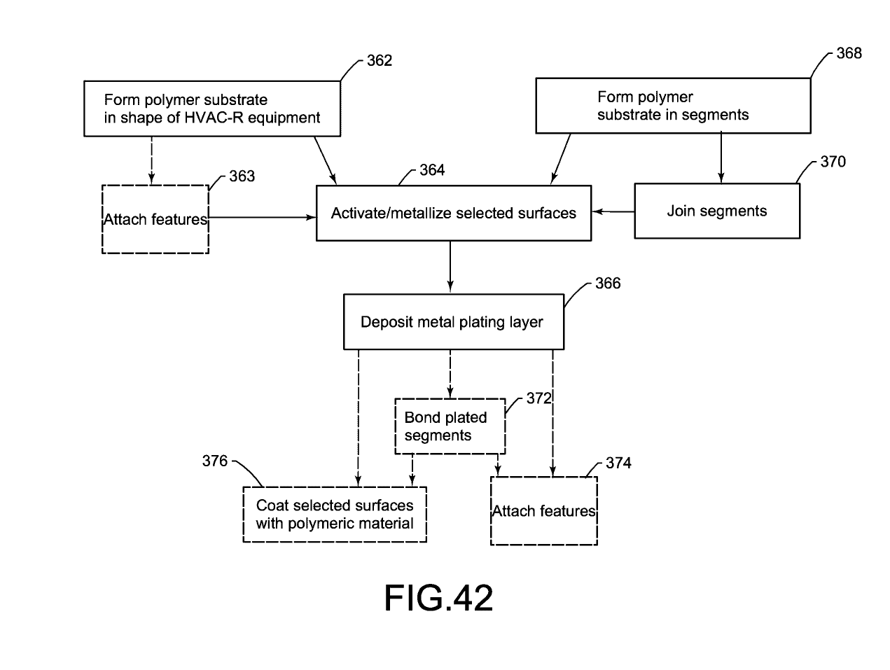

Different methods for fabricating the plated polymeric HVACR equipment 350 are shown in FIG. 42. Beginning with a first block 362, the polymeric substrate 354 may be formed from selected thermoplastic materials or thermoset materials (with optional reinforcement) in a shape of the desired HVACR equipment. It may be formed in the desired shape using a range of polymer molding processes apparent to those skilled in the art such as, but not limited to, injection molding, compression molding, blow molding, additive manufacturing (liquid bed, powder bed, deposition), or composite layup (autoclave, compression, or liquid molding). To simplify the mold tooling, additional features such as mounting features (e.g., flanges or bosses) may be attached to the polymeric substrate 354 after the block 362, according to an optional block 363. Such features may be attached by bonding using a suitable adhesive. Following the block 362 (or the optional block 363), interior or exterior surfaces of the polymeric substrate 354 which are selected for plating with the metallic plating layer 356 may be suitably activated and metallized according to a next block 364. Activation and metallization of the selected surfaces of the polymeric substrate 354 may be carried out using well-established methods in the industry and may result in metallic (conductive) surfaces being formed on the treated surfaces of the polymeric substrate 354, allowing the subsequent deposition of the metallic plating layer(s) 356 thereon.

Following the block 364, one or more metallic plating layer 356 may be deposited on the activated/metallized surfaces of the polymeric substrate 354 according to a next block 366. Deposition of the metallic plating layer(s) 356 may be carried out using metal deposition methods apparent to those skilled in the art such as, but not limited to, electroplating, electroless plating, or electroforming. If desired, masking of selected surfaces of the polymeric substrate 354 may be employed to yield different thicknesses of the metallic plating layer or no plating on the selected areas, as will be understood by those skilled in the art. In addition, if desired, a customized metallic plating layer thickness profile on the surfaces of the polymeric substrate 354 may be achieved using tailored racking tools (e.g., shields, thieves, conformal anodes, etc.), as will be understood by those skilled in the art. Customization of the thickness profile of the metallic plating layer(s) 356 by masking and/or by the use of tailored racking tools may allow for optimization of desired properties (e.g., fire resistance, structural support, surface characteristics, erosion and corrosion resistance, etc.) of the HVACR equipment 350, without adding undue weight to the HVACR equipment to accommodate each of these properties.

As an alternative method to fabricate the plated polymeric HVACR equipment 350, the polymeric substrate 354 may be formed in two or more segments according to a block 368, as shown. The segments of the polymeric substrate 354 may be formed in desired shapes from the above-described thermoplastic or thermoset materials (with optional reinforcement) using one or more of the polymer molding processes described above. Following the block 368, the polymer segments may be joined to form the full-scale polymeric substrate 354, according to a next block 370, as shown. Joining of the polymer segments may be achieved using conventional processes such as welding (ultrasonic, laser, friction, friction-stir, traditional, etc.), adhesive bonding, or formation of mitered joints (with or without adhesive), as will be apparent to those skilled in the art. Upon completion of the block 370, selected surfaces of the polymeric substrate 354 may be suitably activated and metallized (block 364) and one or more metallic plating layers 356 may be deposited on the activated/metallized surfaces (block 366), using the activation/metallization and metal deposition methods (with the optional masking and/or tailored racking methods) described above.

As another alternative fabrication method, selected surfaces of each of the polymer segments formed by the block 368 may be activated and metallized (block 364) and one or more metallic plating layers 356 may be deposited on the activated/metallized surfaces of each of the polymer segments (block 366). The plated segments may then be bonded together to form the full-scale HVACR equipment 350 according to the block 372, as shown. Bonding of the plated segments may be achieved using transient liquid phase (TLP) bonding, as will be understood by those skilled in the art.

Once the plated polymeric HVACR equipment 350 is formed by one of the above-described methods, if desired, it may be further processed according to the optional blocks 374 and/or 376, as shown. For example, additional features (e.g., bosses, inserts, etc.) may be attached to the HVACR equipment 350 according to the optional block 374. Attachment of such additional features may be achieved using a suitable adhesive, a fastener (e.g., rivets, bolts, etc.), or another bonding process. In addition, selected surfaces of the HVACR equipment 350 may be coated with one or more polymeric materials according to the optional block 376. Coating of the plated polymeric HVACR equipment 350 may be achieved using conventional processes such as, but not limited to, spray coating or dip coating. In addition, coating of the HVACR equipment 350 with the polymeric material may provide a lightweight, stiff, and strong polymeric-appearing (non-conductive) product.

From the foregoing, it can therefore be seen that the present disclosure can find industrial applicability in many situations such as, but not limited to, situations requiring HVACR equipment with improved resistance to corrosion and erosion. More specifically, the plated polymeric HVACR equipment may be lighter in weight and significantly more corrosion and erosion resistant than HVACR equipment formed from traditional materials and processes. Furthermore, plated polymeric HVACR equipment may offer cost and weight savings over traditional materials and processes. Schedule savings may also be realized given the high-throughput capabilities of the molding and plating processes described herein. In addition, complex geometries of HVACR equipment may be accessed by forming the polymeric substrate in segments later joining them together according to the methods disclosed herein. The technology disclosed herein may have industrial applicability in a wide range of areas such as, but not limited to, HVACR equipment manufacturing and industrial machinery manufacturing.

Plated Polymeric Elevator Structures

Elevator structures such as elevator doors, elevator walls, and hatches are required to be sufficiently strong for applied loads. For this reason, many elevator structures are fabricated from heavy metallic materials. However, elevator performance may be adversely impacted if the elevator structures are too heavy. For example, heavier elevator structures may lead to a reduction in the payload (carrying capacity) of the elevator as well as an increase in maintenance activity. Clearly, there is a need for lightweight and high-strength material constructions for elevator structures.

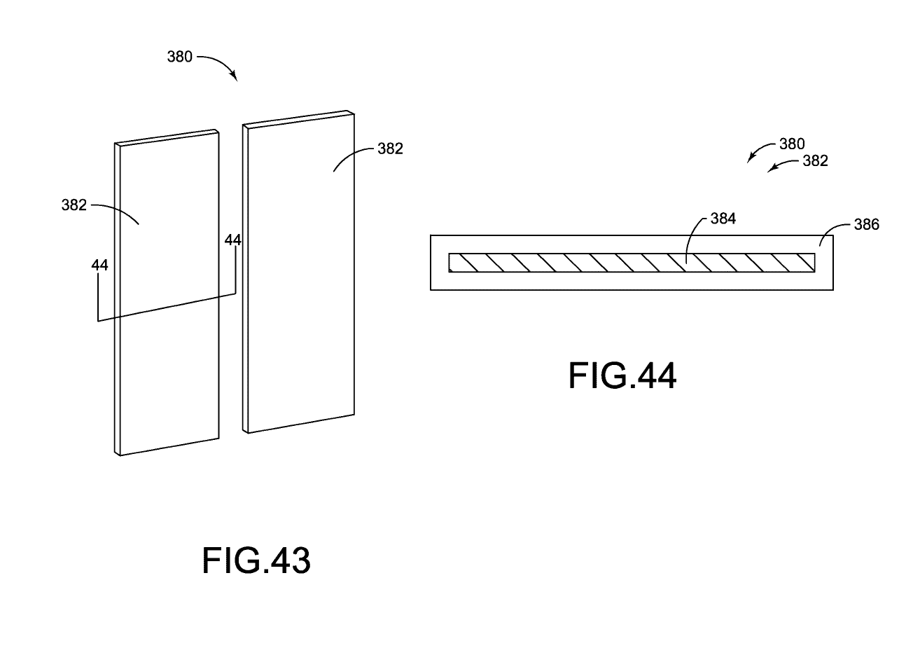

Referring now to FIG. 43, a plated polymeric elevator structure 380 is shown. The plated polymeric elevator structure 380 may form a structural component of an elevator. As a non-limiting example, the plated polymeric elevator structure 380 may be elevator doors 382, as shown. It may also be any other type of elevator structure such as, but not limited to, elevator walls, hatches, and other types of elevator structures. As can be appreciated, the plated polymeric elevator structure 380 may therefore have any shape and size suitable for its intended use. Importantly, by virtue of its plated polymeric construction (see further details below), the plated polymeric elevator structure 380 may be high in strength but lighter in weight than traditional metallic elevator structures of similar shape and dimensions, while maintaining an equivalent load capability. These properties may advantageously result in an increase in the elevator's payload (carrying capacity).

The plated polymeric construction of the elevator structure 380 is best shown in cross-section in FIG. 44. In particular, the plated polymeric elevator structure 380 may consist of a polymeric substrate 384 plated on one or more of its surfaces with one or more metallic plating layers 386, as shown. The polymeric substrate 384 may be formed in the shape of the desired elevator structure, such as the elevator door 382 shown. As one possibility, the polymeric substrate 384 may be plated with one or more metallic plating layers 386 on all of its outer surfaces, as shown. As another possibility, the metallic plating layers 386 may be localized on selected surfaces of the polymeric substrate 384. As another alternative arrangement, the polymeric substrate 384 may be formed as a hollow construction and it may have one or more metallic plating layers 386 deposited on all of its outer surfaces or on selected regions of its outer surfaces.

The polymeric substrate 384 may be formed from a thermoplastic material or a thermoset material, either of which may be optionally reinforced with one or more types of reinforcing materials such as, but not limited to, carbon or glass. Suitable thermoplastic materials may include, but are not limited to, polyetherimide (PEI), thermoplastic polyimide, polyether ether ketone (PEEK), polyether ketone ketone (PEKK), polysulfone, nylon, polyamide, polyphenylene sulfide, polyester, polyimide, and combinations thereof. Suitable thermoset materials may include, but are not limited to, condensation polyimides, addition polyimides, epoxy cured with aliphatic and/or aromatic amines and/or anhydrides, cyanate esters, phenolics, polyesters, polybenzoxazine, polyurethanes, polyacrylates, polymethacrylates, silicones (thermoset), and combinations thereof. Depending on the molding process used to form the polymeric substrate 384, its thickness may vary. For example, the thickness of the polymeric substrate 384 may range from about 0.050 inches (about 1.27 mm) to about 0.25 inches (about 6.35 mm) if it is formed by injection molding, whereas its thickness may range from about 0.050 inches (about 1.27 mm) to about two inches (about 51 mm) if it is formed by compression molding.

The metallic plating layer(s) 386 may consist of one or more metals selected from titanium, nickel, lead, cobalt, copper, iron, gold, silver, palladium, rhodium, chromium, zinc, tin, cadmium, and alloys with any of the foregoing elements comprising at least 50 wt. % of the alloy, and combinations thereof. The metallic plating layer 386 may have an average thickness in the range of about 0.004 inches (about 0.102 mm) to about 0.040 inches (about 1.02 mm), with localized regions having thicknesses in the range of about 0.001 inches (about 0.025 mm) to about 0.1 inches (about 2.5 mm), but other thickness ranges may also apply. This range of metallic plating layer thicknesses may provide the elevator structure 380 with resistance to erosion and/or impact damage. In addition, this range of thicknesses may also offer the option to finish the surfaces of the elevator structure 380 more aggressively to meet tight tolerances and/or surface finish requirements.

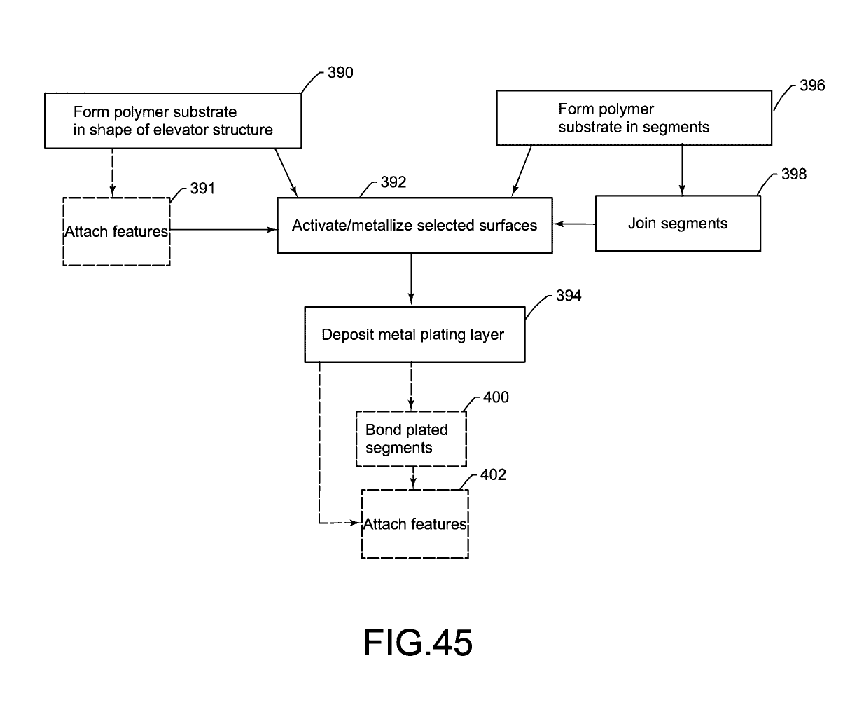

Different methods for fabricating the plated polymeric elevator structure 380 are shown in FIG. 45. Beginning with a first block 390, the polymeric substrate 384 may be formed from selected thermoplastic materials or thermoset materials (with optional reinforcement) in a shape of the desired elevator structure. It may be formed in the desired shape using a range of polymer molding processes apparent to those skilled in the art such as, but not limited to, injection molding, compression molding, blow molding, additive manufacturing (liquid bed, powder bed, deposition), or composite layup (autoclave, compression, or liquid molding). To simplify the mold tooling, additional features such as mounting features (e.g., flanges or bosses) may be attached to the polymeric substrate 384 after the block 390, according to an optional block 391. Such features may be attached by bonding using a suitable adhesive. Following the block 390 (or the optional block 391), surfaces of the polymeric substrate 384 which are selected for plating with the metallic plating layer 386 may be suitably activated and metallized according to a next block 392. Activation and metallization of the selected surfaces of the polymeric substrate 384 may be carried out using well-established methods in the industry and may result in metallic (conductive) surfaces being formed on the treated surfaces of the polymeric substrate 384, allowing the subsequent deposition of the metallic plating layer(s) 386 thereon.

Following the block 392, one or more metallic plating layer 386 may be deposited on the activated/metallized surfaces of the polymeric substrate 354 according to a next block 394. Deposition of the metallic plating layer(s) 386 may be carried out using metal deposition methods apparent to those skilled in the art such as, but not limited to, electroplating, electroless plating, or electroforming. If desired, masking of selected surfaces of the polymeric substrate 384 may be employed to yield different thicknesses of the metallic plating layer (or no plating) on the selected areas, as will be understood by those skilled in the art. In addition, if desired, a customized metallic plating layer thickness profile on the surfaces of the polymeric substrate 384 may be achieved using tailored racking tools (e.g., current shields, thieves, conformal anodes, etc.), as will be understood by those skilled in the art. Customization of the thickness profile of the metallic plating layer(s) 386 by masking and/or by the use of tailored racking tools may allow for optimization of desired properties (e.g., fire resistance, structural support, surface characteristics, erosion and corrosion resistance, etc.) of the elevator structure 380, without adding undue weight to the elevator structure to accommodate each of these properties.

As an alternative method to fabricate the elevator structure 380, the polymeric substrate 384 may be formed in two or more segments according to a block 396, as shown. The segments of the polymeric substrate 384 may be formed in desired shapes from the thermoplastic or thermoset materials (with optional reinforcement) using one or more of the polymer molding processes described above. Following the block 396, the polymer segments may be joined to form the full-scale polymeric substrate 384, according to a next block 398, as shown. Joining of the polymer segments may be achieved using conventional processes such as welding (ultrasonic, laser, friction, friction-stir, traditional, etc.), adhesive bonding, or the formation of mitered joints (with or without adhesive), as will be apparent to those skilled in the art. Upon completion of the block 398, selected surfaces of the polymeric substrate 384 may be suitably activated and metallized (block 392) and one or more metallic plating layers 386 may be deposited on the activated/metallized surfaces (block 394), using the activation/metallization and metal deposition methods (with optional masking and/or tailored racking methods) described above.

As another alternative fabrication method, selected surfaces of each of the polymer segments formed by the block 396 may be activated and metallized (block 392) and one or more metallic plating layers 386 may be deposited on the activated/metallized surfaces of each of the polymer segments (block 394). The plated segments may then be bonded together to form the full-scale elevator structure 380 according to a block 400, as shown. Bonding of the plated segments may be achieved using transient liquid phase (TLP) bonding, as will be understood by those skilled in the art.

Once the plated polymeric elevator structure 380 is formed by one of the above-described methods, if desired, it may be further processed according to the optional block 402, as shown. The optional block 402 may involve the attachment of additional features (e.g., bosses, inserts, etc.) to the plated polymeric elevator structure 380. Attachment of such additional features may be achieved using a suitable adhesive, a fastener (e.g., rivets, bolts, etc.), or another bonding process.

From the foregoing, it can therefore be seen that the present disclosure can find industrial applicability in many situations such as, but not limited to, situations requiring lightweight elevator structures with high load carrying capabilities. In particular, the plated polymeric elevator structures as disclosed herein may offer lighter weight alternatives for existing elevator structured formed from traditional materials and processes. The metallic plating layer may also impart the plated polymeric elevator structures with significant structural strength, such that its load carrying capability may be at least equivalent or greater than similarly-dimensioned metallic elevator structures. The lightweight plated polymeric elevator structures having an equivalent or higher load capability compared with traditional elevator structures and may provide elevators with a larger payload and/or reduced maintenance activity with a given motor size and lift equipment. In addition, complex geometries for elevator structures may be accessed by forming the polymeric substrate in segments and joining them together according to the methods disclosed herein. The technology as disclosed herein may have applicability in a wide range of areas such as, but not limited to, elevator and building construction.

Plated Polymeric Robotic Components

Robots are playing an increasing role in a variety of areas such as, but not limited to, the military, industrial manufacturing, space exploration, scientific instrumentation, and medicine. Generally, robots perform a variety of automatic or semi-automatic functions such as moving, operating mechanical limbs, and sensing and responding to the environment. Robots are constructed from numerous components which may include linkages, joints, end effectors, wheels, tracks, casters, brackets, gears, actuator components, and body components. End effectors may be a device at the end of a robotic arm that is designed to interact with the environment. Examples of end effectors include, but are not limited to, impactive end effectors (e.g., jaws, claws, etc.) which grasp objects in the environment, ingressive end effectors (e.g., pins, needles, hackles, etc.) which penetrate objects, and astrictive end effectors (e.g., vacuum, magneto, electro-adhesion, etc.) which apply suction forces to the surface of objects. However, inertia associated with some robotic components may lead to increased power requirements for the operation of the robot, limited speed for movement of the robot, as well as increased operation safety risks. To reduce power needs for robot operation and to mitigate some safety risks associated with operation, there is a need for lighter-weight and lower-inertia constructions for robotic components.

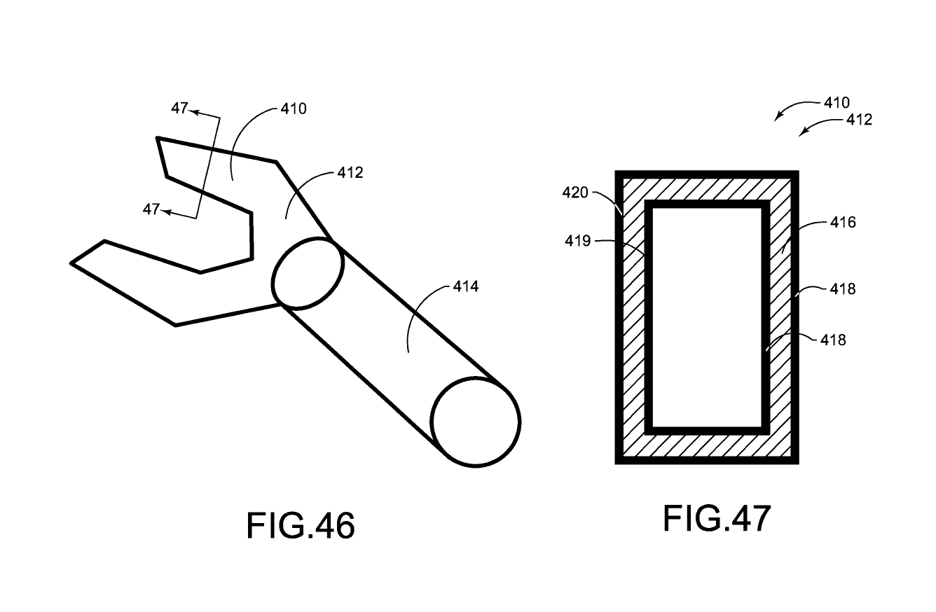

Referring now to FIG. 46, a plated polymeric robotic component 410 is shown. The plated polymeric robotic component 410 may form a structural or operative component of any type of robot such as, but not limited to, mobile robots and industrial robots. As a non-limiting example, the plated polymeric robotic component 410 may be a robotic claw 412 connected to a robotic arm 414 which in turn may be connected to the body of the robot. It may also be several other types of robotic components such as, but not limited to, linkages, joints, wheels, tracks, casters, brackets, gears, actuator components, body components, and other types of end effectors such as impactive end effectors (e.g., jaws, etc.), ingressive end effectors (e.g., pins, needles, hackles, etc.), astrictive end effectors (vacuum, magneto, electro-adhesion, etc.), and contigutive end effectors, as will be apparent to those skilled in the art. As can be appreciated, the plated polymeric robotic component 410 may therefore have a range of geometries and sizes depending on its intended use. Importantly, by virtue of its plated polymeric construction (see further details below), the plated polymeric robotic component 410 may be high in structural strength and light in weight, such that it may be associated with relatively low inertia. These properties may advantageously result in reduced power needs, increased operating speeds, and mitigated safety risks associated with robot operation.

The plated polymeric construction of the robotic component 410 is best shown in cross-section in FIG. 47. In particular, FIG. 47 shows the walls of the robotic claw 412 with internal components (e.g., electrical components, etc.) and the back wall removed for clarity purposes. The plated polymeric robotic component 410 may consist of a polymeric substrate 416 plated on one or more of its internal surfaces 419 or external surfaces 420 with one or more metallic plating layers 418. The polymeric substrate 416 may be formed in the shape of the desired robotic component, such as the robotic claw 412 shown in FIG. 41. As one possibility, the polymeric substrate 414 may be plated with one or more metallic plating layers 418 on both its internal surfaces 419 and its external surfaces 420, as shown in FIG. 47. As another possibility, the polymeric substrate 416 may have one or more metallic plating layers only on its interior surface 419 or only on its exterior surface 420. Alternatively, one or more metallic plating layers 418 may be deposited on selected regions of either or both of the internal surface 419 and the external surface 420.

The polymeric substrate 416 may be formed from a thermoplastic material or a thermoset material, either of which may be optionally reinforced with one or more types of reinforcing materials such as, but not limited to, carbon or glass. Suitable thermoplastic materials may include, but are not limited to, polyetherimide (PEI), thermoplastic polyimide, polyether ether ketone (PEEK), polyether ketone ketone (PEKK), polysulfone, polyamide, polyphenylene sulfide, polyester, polyimide, and combinations thereof. Suitable thermoset materials may include, but are not limited to, condensation polyimides, addition polyimides, epoxy cured with aliphatic and/or aromatic amines and/or anhydrides, cyanate esters, phenolics, polyesters, polybenzoxazine, polyurethanes, polyacrylates, polymethacrylates, silicones (thermoset), and combinations thereof. Depending on the molding process used to form the polymeric substrate 416, its thickness may vary. For example, the thickness of the polymeric substrate 416 may range from about 0.050 inches (about 1.27 mm) to about 0.25 inches (about 6.35 mm) if it is formed by injection molding, whereas its thickness may range from about 0.050 inches (about 1.27 mm) to about two inches (about 51 mm) if it is formed by compression molding.

The metallic plating layer(s) 418 may consist of one or more metals selected from titanium, nickel, lead, cobalt, copper, iron, gold, silver, palladium, rhodium, chromium, zinc, tin, cadmium, and alloys with any of the foregoing elements comprising at least 50 wt. % of the alloy, and combinations thereof. The metallic plating layer 418 may have an average thickness in the range of about 0.004 inches (about 0.102 mm) to about 0.04 inches (about 1.02 mm), with localized regions having thicknesses in the range of about 0.001 inches (about 0.025 mm) to about 0.050 inches (about 1.27 mm), but other thickness ranges may also apply. This range of metallic plating layer thicknesses may provide the robotic component 410 with resistance to erosion and/or impact damage. In addition, this range of thicknesses may also offer the option to finish the surfaces of the robotic component 410 more aggressively to meet tight tolerances and/or surface finish requirements.

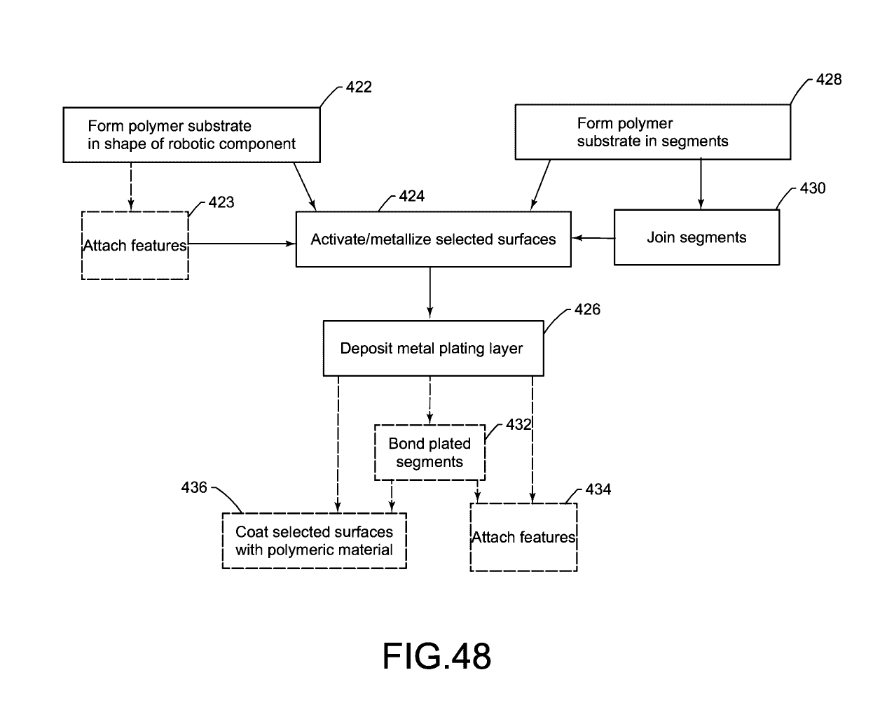

Different methods for fabricating the plated polymeric robotic component 410 are shown in FIG. 48. Beginning with a first block 422, the polymeric substrate 416 may be formed from selected thermoplastic materials or thermoset materials (with optional reinforcement) in a shape of the desired robotic component. It may be formed in the desired shape using a range of polymer molding processes apparent to those skilled in the art such as, but not limited to, injection molding, compression molding, blow molding, additive manufacturing (liquid bed, powder bed, deposition), or composite layup (autoclave, compression, or liquid molding). To simplify the mold tooling, additional features such as mounting features (e.g., flanges or bosses) may be attached to the polymeric substrate 416 after the block 422, according to an optional block 423. Such features may be attached by bonding using a suitable adhesive. Following the block 422 (or the optional block 423), internal or external surfaces of the polymeric substrate 416 which are selected for plating with the metallic plating layer 418 may be suitably activated and metallized according to a next block 424. Activation and metallization of the selected surfaces of the polymeric substrate 416 may be carried out using well-established methods in the industry and may result in metallic (conductive) surfaces being formed on the treated surfaces of the polymeric substrate 416, allowing the subsequent deposition of the metallic plating layer(s) 418 thereon.

Following the block 424, one or more metallic plating layer 418 may be deposited on the activated/metallized surfaces of the polymeric substrate 416 according to a next block 426. Deposition of the metallic plating layer(s) 418 may be carried out using metal deposition methods apparent to those skilled in the art such as, but not limited to, electroplating, electroless plating, or electroforming. If desired, masking of selected surfaces of the polymeric substrate 416 may be employed to yield different thicknesses of the metallic plating layer or no plating on the selected areas, as will be understood by those skilled in the art. In addition, if desired, a customized metallic plating layer thickness profile on the surfaces of the polymeric substrate 416 may be achieved using tailored racking tools (e.g., shields, thieves, conformal anodes, etc.), as will be understood by those skilled in the art. Customization of the thickness profile of the metallic plating layer(s) 418 by masking and/or by the use of tailored racking tools may allow for optimization of desired properties (e.g., fire resistance, structural support, surface characteristics, etc.) of the robotic component 410, without adding undue weight to the robotic component to accommodate each of these properties.

As an alternative method to fabricate the plated polymeric robotic component 410, the polymeric substrate 416 may be formed in two or more segments according to a block 428, as shown. The segments of the polymeric substrate 416 may be formed in desired shapes from the thermoplastic or thermoset materials (with optional reinforcement) using one or more of the polymer molding processes described above. Following the block 428, the polymer segments may be joined to form the full-scale polymeric substrate 416, according to a next block 430, as shown. Joining of the polymer segments may be achieved using conventional processes such as welding (ultrasonic, laser, friction, friction-stir, traditional, etc.), adhesive bonding, or formation of mitered joints (with or without adhesive), as will be apparent to those skilled in the art. Upon completion of the block 430, selected surfaces of the polymeric substrate 416 may be suitably activated and metallized (block 424) and one or more metallic plating layers 418 may be deposited on the activated/metallized surfaces (block 426), using the activation/metallization and metal deposition methods (with optional masking and/or tailored racking methods) described above.

As another alternative fabrication method, selected surfaces of each of the polymer segments formed by the block 428 may be activated and metallized (block 424) and one or more metallic plating layers 418 may be deposited on the activated/metallized surfaces of each of the polymer segments (block 426). The plated segments may then be bonded together to form the full-scale robotic component 410 according to the block 432, as shown. Bonding of the plated segments may be achieved using transient liquid phase (TLP) bonding, as will be understood by those skilled in the art.

Once the plated polymeric robotic component 410 is formed by one of the above-described methods, if desired, it may be further processed according to the optional blocks 434 and/or 436, as shown. For example, additional features (e.g., bosses, inserts, etc.) may be attached to the robotic component 410 according to the optional block 434. Attachment of such additional features may be achieved using a suitable adhesive, a fastener (e.g., rivets, bolts, etc.), or another bonding process. In addition, selected surfaces of the robotic component 410 may be coated with one or more polymeric materials according to the optional block 436. Coating of the plated polymeric robotic component 410 may be achieved using conventional processes such as, but not limited to, spray coating or dip coating. In addition, coating of the robotic component 410 with the polymeric material may provide a lightweight, stiff, and strong polymeric-appearing (non-conductive) product.

From the foregoing, it can therefore be seen that the present disclosure can find industrial applicability in many situations such as, but not limited to, situations requiring lightweight and high-strength robotic components. In particular, the plated polymeric robotic components as disclosed herein may offer lightweight and high-strength alternatives for existing robotic components formed from traditional materials and processes. The plated polymeric robotic components may have reduced inertia which may lead to advantageous reductions in power needs and increases in operating speeds. Even further, such reduced inertia may also mitigate some safety risks associated with robot operation. The technology as disclosed here may have applicability in a wide range of areas such as, but not limited to, robotics, instrumentation, and automotive applications.

What is claimed is:

1. An industrial product, comprising:
a polymer substrate formed in a shape of the industrial product; and
a metallic plating layer plated on at least one surface of the industrial product.

2. The industrial product of claim 1, wherein the industrial product is nuclear waste equipment.

3. The industrial product of claim 2, wherein the nuclear waste equipment is a nuclear waste container having an inner cavity configured to contain nuclear waste.

4. The industrial product of claim 2, wherein the metallic plating layer contains at least one radiation-shielding metal.

5. The industrial product of claim 1, wherein the industrial product is industrial equipment configured to be exposed to saline.

6. The industrial product of claim 5, wherein the industrial equipment is a submersible vehicle.

7. The industrial product of claim 5, wherein the industrial equipment is selected from the group consisting of a submsersible vehicle, desalination equipment, a vehicle structural frame, a hull structural frame, optical viewing equipment for an unmanned underwater vehicle, an unmanned underwater vehicle control device, and an unmanned underwater vehicle manipulation arm.

8. The industrial product of claim 1, wherein the industrial product is a satellite component.

9. The industrial product of claim 1, wherein the industrial product is a satellite.

10. The industrial product of claim 1, wherein the industrial product is HVACR equipment.

11. The industrial product of claim 10, wherein the HVACR equipment comprises a heater, a hot water heater, an air conditioning unit, a refrigerator, or a component contained within any of the foregoing.

12. The industrial product of claim 11, wherein the component is selected from a group consisting of a heat exchanger, a pipe, a fitting, a fastener, a flange, a pump, a valve, a drain, a tank, and filtration equipment.

13. The industrial product of claim 10, wherein the metallic plating layer consists of titanium.

14. An industrial product including a polymer substrate formed in a shape of the industrial product and a metallic plating layer deposited on at least one surface of the polymer substrate, the industrial product being fabricated by a method comprising:
forming the polymer substrate in the shape of the industrial product;
activating and metallizing the at least one surface of the polymer substrate; and
depositing the metallic plating layer on the at least one surface of the polymer substrate to provide the industrial product.

15. The industrial product of claim 14, wherein the industrial product is nuclear waste equipment.

16. The industrial product of claim 14, wherein the industrial product is industrial equipment configured to be exposed to saline.

17. The industrial product of claim 14, wherein the industrial product is a satellite component.

18. The industrial product of claim 14, wherein the industrial product is HVACR equipment.

19. A method for fabricating an industrial product, comprising:
forming a polymer substrate in a shape of the industrial product;
activating and metallizing at least one surface of the polymer substrate; and
depositing a metallic plating layer on the at least one surface of the polymer substrate to provide the industrial product.

20. The method of claim 19, wherein the method further comprises:
forming the polymer substrate in segments;
activating and metallizing selected surfaces of the segments; and
bonding the activated and metallized surfaces of the segments by transient liquid phase bonding to provide the industrial product.
